(19) United States
(12) Patent Application Publication
(10) Pub. No.: US 2015/0207178 A1
(43) Pub. Date: Jul. 23, 2015

(54) BATTERY MODULE

(71) Applicant: NEC ENERGY DEVICES, LTD., Sagamihara-shi, Kanagawa (JP)

(72) Inventor: Toru Suzuki, Sagamihara-shi (JP)

(73) Assignee: NEC ENERGY DEVICES, LTD., Sagamihara-shi, Kanagawa (JP)

(21) Appl. No.: 14/421,074

(22) PCT Filed: Jul. 30, 2013
(86) PCT No.: PCT/JP2013/070551

§ 371 Date: Feb. 11, 2015

(30) Foreign Application Priority Data
Aug. 27, 2012 (JP) 2012-186341

(51) Int. Cl. H01M 10/0585; H01M 10/0525

(52) U.S. Cl. CPC H01M 10/0585; H01M 10/0525; H01M 2220/10

(57) ABSTRACT

To provide a battery module having excellent vibration resistance/impact resistance, a battery module according to the present invention is constructed by an electrode laminate 60 obtained by laminating positive and negative electrodes through separators and a laminate film exterior material 90 housing the electrode laminate 60 and electrolyte and has an impact resistance against an impact of at least G. In the battery module, a relationship of μ_{eff}<μ1 is established between an effective static friction coefficient μ_{eff} between the outermost layer of the electrode laminate 60 and an inner layer of the laminate film exterior material 90 in a state where the electrolyte is poured in the laminate film exterior material and a static friction coefficient μ1 which is a larger one of a static friction coefficient between the positive electrode and the separator and that between the negative electrode and the separator, and a relationship of mG<2PAμ_{eff} is established among a weight m of the electrode laminate 60, a contacting area A between the outermost layer of the electrode laminate 60 and the inner layer of the laminate film exterior material 90, and an atmospheric pressure P.

### TECHNICAL FIELD

The present invention relates to a battery module constructed using a secondary unit battery such as a lithium ion battery.

### BACKGROUND ART

Recently, as a solution for environmental problems, clean energy which can be obtained by wind power generation, solar power generation, or the like and can be used for household uses (for detached houses, etc.) or for industrial uses (for transport equipment, construction equipment, etc.) is attracting attention. However, the clean energy has a disadvantage in that output variation becomes large depending on the situation. For example, energy by the solar power generation can be obtained in the daytime where the sun is shining, while it cannot be obtained at night where the sun sets.

To stabilize the output of the clean energy, technology that temporarily stores the clean energy in a battery is used. For example, solar energy thus stored in the battery becomes available at night where the sun sets. In general, a lead battery has been used as a battery for storing the clean energy; however, the lead battery has a disadvantage in that it is generally large in size and low in energy density.

Thus, recently, a lithium ion secondary battery capable of operating at normal temperature and having a high energy density is attracting attention. In addition to the high energy density, the lithium ion secondary battery has a low impedance and is thus excellent in responsiveness.

For example, as the lithium ion battery, a laminate battery in which a battery element is encapsulated inside a flexible film is known. The laminate battery generally has a flat plate-like shape and has a configuration in which positive and negative electrodes are drawn outside the flexible film.

There is known technology in which two or more laminate batteries each having the above configuration are modularized by being connected in series and housed in a casing for the purpose of increasing capacity.

For example, Patent Document 1 (Japanese Patent No. 3,970,684) discloses a battery module constituted by a battery pack constructed by connecting four sheet-like battery cells in series and a thin rectangular parallelepiped casing that houses the battery pack.

### [Patent Document 1]

Japanese Patent No. 3,970,684

### DISCLOSURE OF THE INVENTION

### Problems to be Solved by the Invention

In a battery module as disclosed in Patent Document 1, in which the laminate battery is incorporated in the casing, an electrode laminate provided in the laminate film is designed to be slightly displaced even though a unit battery is fixed inside the casing by fixing an area around the laminated battery to the casing by bonding or the like, or screw-fixing a lead-out tab of the battery to the casing. Thus, when a long-time vibration or impact is applied to the battery module, the electrode laminate acts as a pendulum, which may cause breakage of the laminate film and leakage of electrolyte due to the breakage, cause rupture of a collector conductively connecting the electrode laminate and the lead-out tab, or cause rupture of the lead-out tab.

### Means for Solving the Problems

To solve the above problem, according to an aspect of the present invention, there is provided a battery module constructed by an electrode laminate obtained by laminating positive and negative electrodes through separators and a laminate film exterior material housing the electrode laminate and electrolyte and having an impact resistance against an impact of at least G, wherein a relationship of μ_{eff}<μ1 is established between an effective static friction coefficient μ_{eff} between the outermost layer of the electrode laminate and an inner layer of the laminate film exterior material in a state where the electrolyte is filled in the laminate film exterior material and a static friction coefficient μ1 which is a larger one of a static friction coefficient between the positive electrode and the separator and that between the negative electrode and the separator, and a relationship of mG<2PAμ_{eff} is established among a weight m of the electrode laminate, a contacting area A between the outermost layer of the electrode laminate and the inner layer of the laminate film exterior material, and an atmospheric pressure P.

Further, according to another aspect of the present invention, there is provided a battery module constructed by an electrode laminate obtained by laminating positive and negative electrodes through separators and a laminate film exterior material housing the electrode laminate and electrolyte and having an impact resistance against an impact of at least G, wherein a relationship of μ_{eff}<μ1 is established between an effective static friction coefficient μ_{eff} between the outermost layer of the electrode laminate and an inner layer of the laminate film exterior material in a state where the electrolyte is poured in the laminate film exterior material and a static friction coefficient μ1 which is a larger one of a static friction coefficient between the positive electrode and the separator and that between the negative electrode and the separator, and a relationship of T<2PAμ_{eff}/10³ dG is established among a thickness T of the electrode laminate, a specific gravity d of the electrode laminate, a contacting area A between the outermost layer of the electrode laminate and the inner layer of the laminate film exterior material, and an atmospheric pressure P.

Further, in the battery module according to the present invention, assuming that a static friction coefficient between the outermost layer of the electrode laminate and the inner layer of the laminate film exterior material in a state where the electrolyte is not present is μ, the effective static friction coefficient is calculated based on μ_{eff}=eμ.

Further, in the battery module according to the present invention, the e assumes a value in a range of 0.11≦e≦0.12.

Further, in the battery module according to the present invention, the unit battery is a lithium ion secondary battery.

### Advantages of the Invention

According to the battery module of the present invention, the relationship of mG<2PAμ_{eff} which is a condition under which the electrode laminate 60 itself is not moved even when the impact G is applied to the battery module 1000 is established. Thus, it is possible to provide the battery module having excellent vibration resistance/impact resistance, and thus capable of reducing probability of occurrence of breakage of the laminate film exterior material and leakage of electrolyte due to the breakage, occurrence of rupture of a collector conductively connecting the electrode laminate and lead-out tab, or occurrence of rupture of the lead-out tab even when a long-time vibration or impact is applied to the battery module.

### BRIEF DESCRIPTION OF THE DRAWINGS

FIGS. 1A to 1C are views each illustrating a unit battery 100 constituting a battery module according to an embodiment of the present invention and its preliminary processing process.

FIG. 2 is a view explaining a unit battery housing 800 used to form the battery module according to the embodiment of the present invention.

FIG. 3 is a view explaining the unit battery housing 800 used to form the battery module according to the embodiment of the present invention.

FIGS. 4A and 4B are views each explaining mounting of a first connector 828 to the unit battery housing 800.

FIG. 5 is a view explaining mounting of a second connector 840 to a connector mounting panel 847.

FIG. 6 is a view explaining mounting of the connector mounting panel 847 to the unit battery housing 800.

FIG. 7 is a front view of the second connector 840 mounted to the unit battery housing 800.

FIG. 8 is a view explaining a production process of the battery module according to the embodiment of the present invention.

FIG. 9 is a view explaining a production process of the battery module according to the embodiment of the present invention.

FIG. 10 is a view explaining a production process of the battery module according to the embodiment of the present invention.

FIG. 11 is a view explaining a production process of the battery module according to the embodiment of the present invention.

FIG. 12 is a view explaining a production process of the battery module according to the embodiment of the present invention.

FIG. 13 is a view explaining a production process of the battery module according to the embodiment of the present invention.

FIG. 14 is a view explaining a production process of the battery module according to the embodiment of the present invention.

FIG. 15 is a view explaining a production process of the battery module according to the embodiment of the present invention.

FIG. 16 is a perspective view illustrating the battery module according to the embodiment of the present invention in an exploded manner.

FIG. 17 is a perspective view illustrating the battery module 1000 according to the embodiment of the present invention.

FIGS. 18A and 18B are views each explaining an internal structure of the battery module 1000 according to the embodiment of the present invention.

FIG. 19 is a view explaining an internal structure of the unit battery 100 and atmospheric pressure applied to the unit battery 100.

FIG. 20 is a view explaining a static friction coefficient in the unit battery 100.

FIG. 21 is a view explaining parameters related to the electrode laminate 60.

FIG. 22 is a view explaining displacement of positive electrodes, negative electrodes, and separators in the electrode laminate 60.

FIG. 23 is a view explaining a production process of a battery management circuit unit 1100.

FIG. 24 is a view explaining a production process of the battery management circuit unit 1100.

FIG. 25 is a view explaining a production process of the battery management circuit unit 1100.

FIG. 26 is a view illustrating the battery management circuit unit 1100.

FIG. 27 is a view illustrating an overview of a power storage device 1200 using the battery module 1000 according to the present invention.

FIG. 28 is a view explaining a relay board 1150 of the power storage device 1200.

FIG. 29 is a view illustrating an overview of the power storage device 1200 using the battery module 1000 according to the present invention.

FIGS. 30A to 30C are views each explaining a configuration around the second connector 840 of the battery module 1000 according to the embodiment of the present invention.

FIG. 31 is a view illustrating an overview of the power storage device 1200 using the battery module 1000 according to the embodiment of the present invention.

FIG. 32 is a view illustrating an overview of the power storage device 1200 using the battery module 1000 according to the embodiment of the present invention.

### BEST MODE FOR CARRYING OUT THE INVENTION

An embodiment of the present invention will be described below with reference to the drawings.

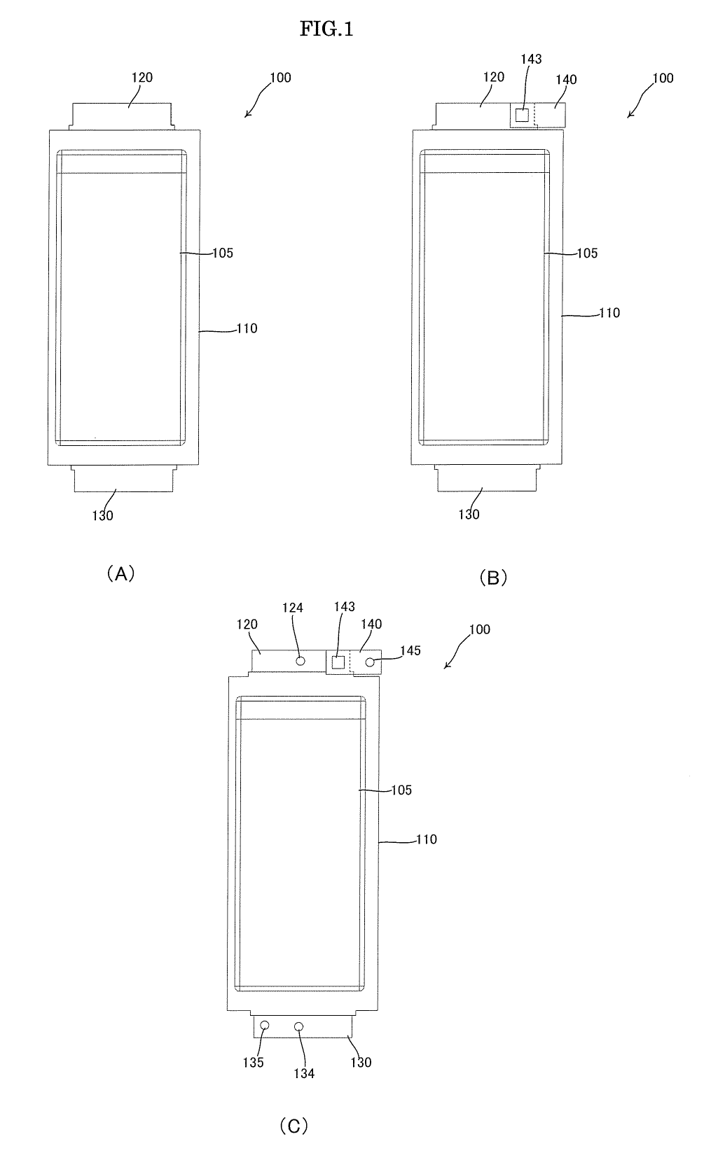

FIGS. 1A to 1C are views each illustrating a unit battery 100 constituting a battery module according to an embodiment of the present invention and its preliminary processing process. As the unit battery 100, a lithium ion secondary battery as a kind of an electrochemical element, in which lithium ion is moved between positive and negative electrodes to perform charging and discharging is used.

FIG. 1A illustrates the unit battery 100 before the preliminary processing. A battery body 110 of the unit battery 100 has a structure in which an electrode laminate (not illustrated) obtained by laminating a plurality of sheet-like positive electrodes and a plurality of sheet-like negative electrodes through separators and electrolyte (not illustrated) are housed in a laminate film exterior material having a rectangular shape in a plan view. A positive electrode lead-out tab 120 and a negative electrode lead-out tab 130 are drawn, respectively, from one end portion (side) of the battery body 110 and the other end portion (side) opposite to the one end portion. A laminating direction in which the plurality of sheet-like positive electrodes and plurality of negative sheet-like electrodes are laminated through the separators is defined as a sheet thickness direction.

The positive electrode lead-out tab 120 and the negative electrode lead-out tab 130 each have a planar shape and are connected, inside the laminate film exterior material, to the sheet-like positive electrodes and sheet-like negative electrodes, respectively, directly or through a lead body. The laminate film exterior material is constituted by a metal laminate film having a heat sealing resin layer. More specifically, for example, two metal laminate film are put one over the other with the heat sealing resin layers facing each other to form the laminate film exterior material, and an outer periphery of the laminate film exterior material is heat-sealed with the electrode laminate including the sheet-like positive electrodes, sheet-like negative electrodes, and separators and electrolyte housed inside the laminate film exterior material, whereby the laminate film exterior material is internally hermetically sealed.

Here, a metal piece such as the positive electrode lead-out tab 120 or negative electrode lead-out tab 130 drawn from the battery body 110 including the laminate film exterior material is referred to as “lead-out tab”, and the sheet-like positive electrode or sheet-like negative electrode laminated to each other through the separators inside the laminate film exterior material is referred to as “electrode”.

The electrode laminate includes, in addition to the above electrode laminate obtained by laminating the plurality of sheet-like positive electrodes and plurality of sheet-like negative electrodes through the separators, an electrode laminate obtained by rolling and compressing a laminated body obtained by laminating the plurality of sheet-like positive electrodes and plurality of sheet-like negative electrodes through the separators.

Generally, in the unit battery 100 as described above, aluminum or an aluminum alloy is used as a material for the positive electrode lead-out tab 120; and nickel, a material (nickel plating material (e.g., nickel-plated copper)) obtained by applying nickel-plating to metal other than the nickel, or a clad (nickel clad material (e.g., nickel-copper clad) of nickel and metal other than the nickel is used as a material for the negative electrode lead-out tab 130. In the present embodiment, the positive electrode lead-out tab 120 is made of aluminum, and the negative electrode lead-out tab 130 is made of nickel-plated copper.

Preliminary processing, which is needed before formation of the battery module, is performed for the thus configured unit battery 100. First, as illustrated in FIG. 1B, an additional tab member 140 made of copper is ultrasonic welded at a welding portion 143 to be connected to the positive electrode lead-out tab 120. A reason for using such an additional tab member 140 will be described.

In forming the battery module according to the present invention, the positive electrode lead-out tab 120 of one unit battery 100 and the negative electrode lead-out tab 130 of another unit battery 100 adjacent to the one unit battery 100 are mechanically fixed to a copper bus bar by a screw for electrical connection.

In the configuration in which the aluminum-containing positive electrode lead-out tab 120 of the unit battery 100 is mechanically fixed to the copper bus bar, conductivity may degrade after elapse of a predetermined time period due to a potential difference.

In order to cope with this, in the battery module according to the present invention, the additional tab member 140 made of copper is joined by welding to the positive electrode lead-out tab 120 of the unit battery 100, as described above. Then, the additional tab member 140 made of copper is mechanically fixed to the bus bar so as to prevent degradation of the conductivity due to a potential difference. With this configuration, electrical connection is achieved by metal materials of the same type at the mechanical electrical connection portion, eliminating the problem of the potential difference, so that degradation of the conductivity hardly occurs over a prolonged period of time.

In a process illustrated in FIG. 1C, a positioning through hole 124 is formed in the positive electrode lead-out tab 120, a through hole 145 is formed in the additional tab member 140 added to the positive electrode lead-out tab 120, and a positioning through hole 134 and a through hole 135 are formed in the negative electrode lead-out tab 130. Of these through holes, the positioning through hole 124 of the positive electrode lead-out tab 120 and the positioning through hole 134 of the negative electrode lead-out tab 130 are used when the unit battery 100 is set in a unit battery housing 800 to be described in detail later.

Unit battery positioning projections 860 are formed in the unit battery housing 800. When the unit battery 100 is placed in the unit battery housing 800, the unit battery positioning projections 860 are made to penetrate the positioning through hole 124 and the positioning through hole 134, respectively. This makes it possible to easily set the unit battery 100 in the unit battery housing 800, thereby achieving high production efficiency.

The through hole 145 of the additional tab member 140 and the through hole 135 of the negative electrode lead-out tab 130 are, as described later, used for the following purposes: (1) to mechanically fix the unit battery 100 to the unit battery housing 800; (2) to electrically connect the tab to the bus bar of the unit battery housing 800; and (3) to electrically connect the tab to a sense line and a power source line.

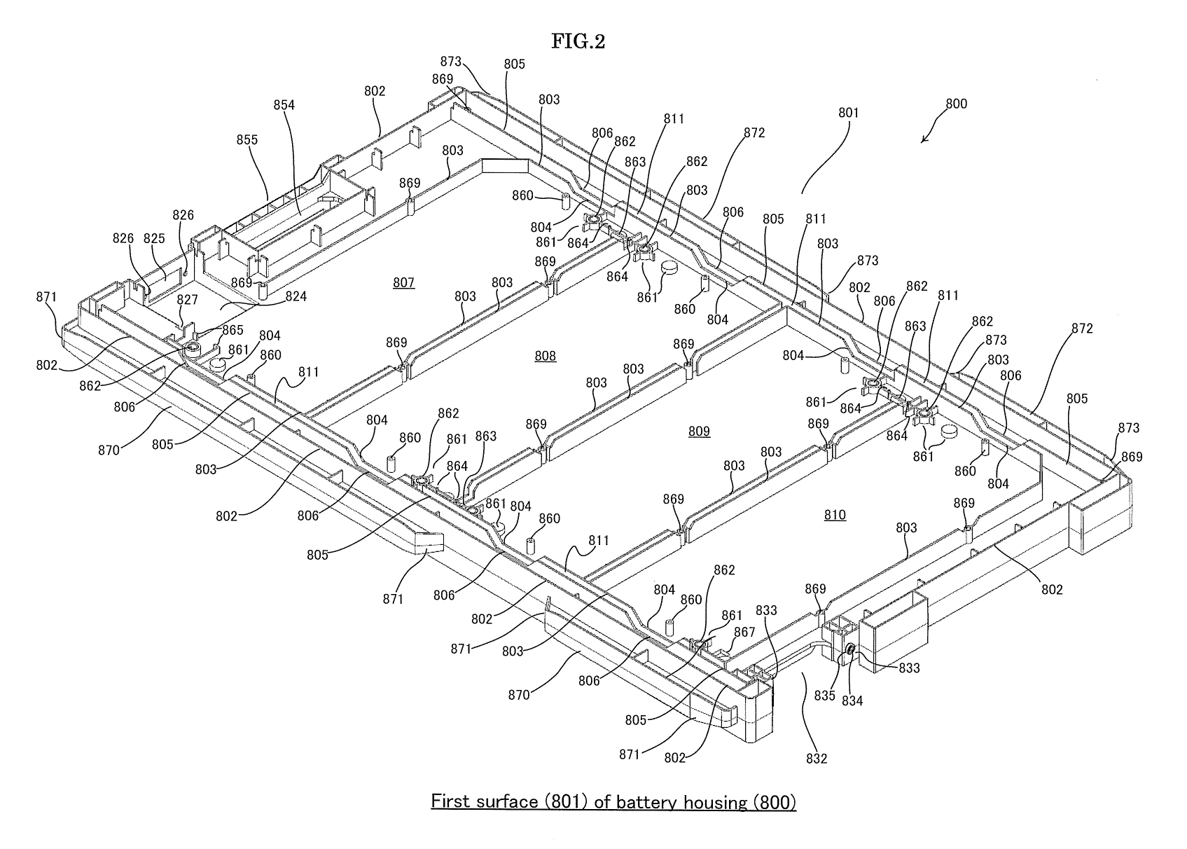

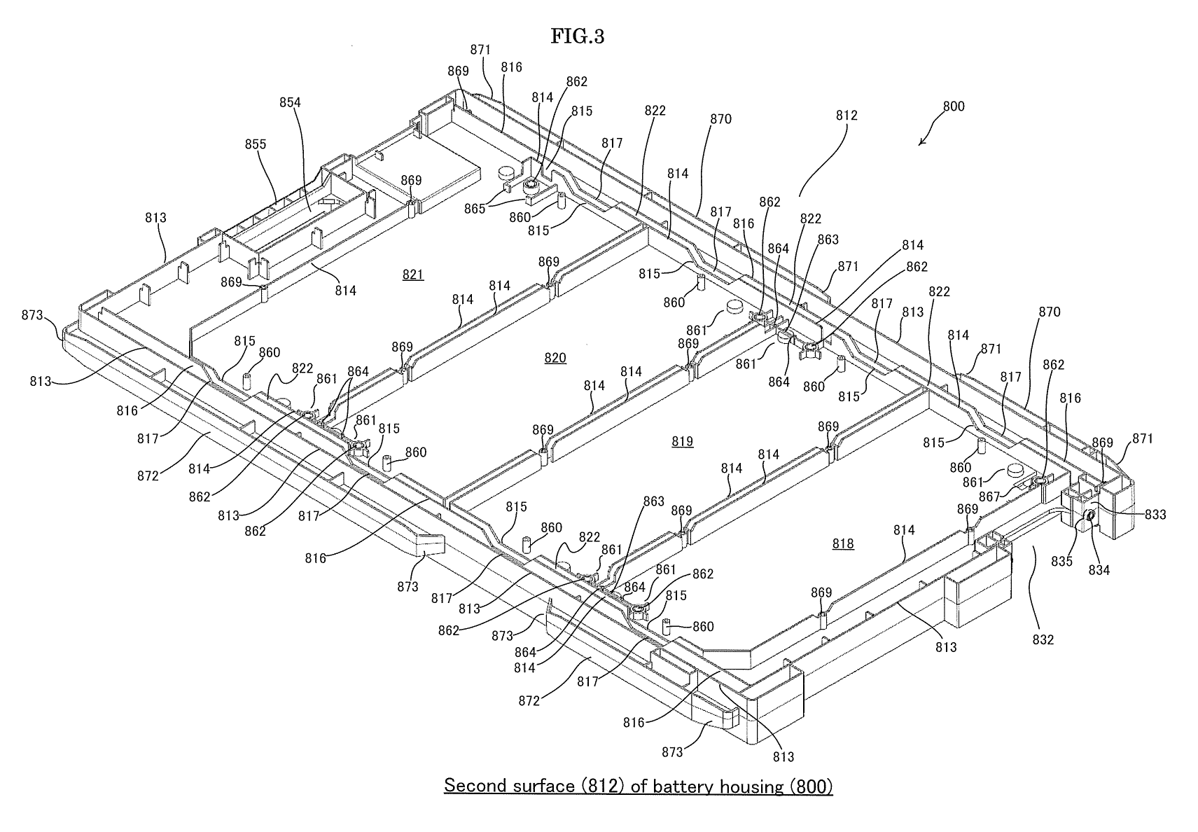

The following describes a detailed configuration of the unit battery housing 800 for housing the unit battery 100 thus subjected to the preliminary processing. FIGS. 2 and 3 are views each explaining the unit battery housing 800 used to form the battery module according to the embodiment of the present invention.

The unit battery housing 800 is a member made of a synthetic resin such as ABS. In the unit battery housing 800, the unit batteries 100 are assembled and wired to each other.

The unit battery housing 800 has a flat plate-like base and a peripheral partition wall portion formed at a peripheral portion of front and rear surfaces constituting main surfaces of the base. The peripheral partition wall portion includes a first surface peripheral partition wall portion formed on the base front surface side and a second surface peripheral partition wall portion formed on the base rear surface side. FIG. 2 is a perspective view of the base front surface side of the unit battery housing 800, and FIG. 3 is a perspective view of the base rear surface side of the unit battery housing 800. The main surface of the battery housing on the base front surface side illustrated in FIG. 2 is referred to as a first surface 801, and the main surface of the battery housing on the base rear surface side illustrated in FIG. 3 is referred to as a second surface 812.

On the first surface 801, a first surface peripheral partition wall portion 802 is vertically installed from the base front surface so as to surround the periphery of the base front surface. An area inside the first surface peripheral partition wall portion 802 is shielded by a cover body to be described later.

In the area on the first surface 801 inside the first surface peripheral partition wall portion 802, a first surface separating partition wall portion 803 is vertically installed on the base front surface. The first surface separating partition wall portion 803 serves as a partition wall between the unit batteries 100 disposed adjacent to each other on the first surface and provides an independent chamber for housing the unit battery 100. Further, the first surface separating partition wall portion 803 functions also as a partition wall of the unit battery positioned at an end portion of the unit battery row. Thus, on the first surface 801 side, four unit battery housing spaces: a first battery housing chamber 807, a second battery housing chamber 808, a third battery housing chamber 809, and a fourth battery housing chamber 810 can be formed by the first surface separating partition wall portion 803.

On one end side of the first surface 801 and the other side thereof opposite to the one end side, a first surface intermediate partition wall portion 805 is vertically installed on the base front surface at an intermediate position between the first surface peripheral partition wall portion 802 and the first surface separating partition wall portion 803. A space between the first surface separating partition wall portion 803 and the first surface intermediate partition wall portion 805 is used as a first surface sense line housing portion 811 in which a sense line for detecting a potential of the tab of the unit battery 100 is routed.

At a portion where a drawing direction of the lead-out tab of the unit battery 100 housed in the housing chamber defined by the first surface separating partition wall portion 803 and the first surface separating partition wall portion 803 cross each other, a separating partition wall cut portion 804 is formed. Similarly, at a portion where the lead-out tab drawing direction and a first surface intermediate partition wall portion 805 cross each other, an intermediate partition wall cut portion 806 is formed.

Even when an abnormality occurs in one of the plurality of unit batteries as a result of the use of the battery module in an abnormal state to cause a necessity of discharging gas generated in the laminate film exterior material to an outside thereof, the separating partition wall cut portion 804 and the intermediate partition wall cut portion 806 function as gas discharging structure for discharging such gas to make it possible to reduce adverse effect on the adjacent unit battery.

Also on the second surface 812, a second surface peripheral partition wall portion 813 is vertically installed on the base rear surface so as to surround a periphery of the base rear surface. An area inside the second surface peripheral partition wall portion 813 is shielded by a cover body to be described later.

In the area on the second surface 812 inside the second surface peripheral partition wall portion 813, a second surface separating partition wall portion 814 is vertically installed from the base front surface. The second surface separating partition wall portion 814 serves as a partition wall between the unit batteries 100 disposed adjacent to each other on the second surface and provides an independent chamber for housing the unit battery 100. Further, the second surface separating partition wall portion 814 functions also as a partition wall of the unit battery positioned at an end portion of the unit battery row. Thus, on the second surface 812 side, four unit battery housing spaces: a fifth battery housing chamber 818, a sixth housing chamber 819, a seventh battery housing chamber 820, and an eighth battery housing chamber 821 can be formed by the second surface separating partition wall portion 814. As a result, in the unit battery housing 800 having the first and second surfaces 801 and 802, a total of eight unit batteries 100 are housed.

On one end side of the second surface 812 and the other side thereof opposite to the one end side, a second surface intermediate partition wall portion 816 is vertically installed on the base front surface at an intermediate position between the second surface peripheral partition wall portion 813 and the second surface separating partition wall portion 814. A space between the second surface separating partition wall portion 814 and the second surface intermediate partition wall portion 816 is used as a second surface sense line housing portion 822 in which the sense line for detecting a potential of the tab of the unit battery 100 is routed.

At a portion where a drawing direction of the lead-out tab of the unit battery 100 housed in the housing chamber defined by the second surface separating partition wall portion 814 and the second surface separating partition wall portion 814 cross each other, a separating partition wall cut portion 815 is formed. Similarly, at a portion where the lead-out tab drawing direction and the second surface intermediate partition wall portion 816 cross each other, an intermediate partition wall cut portion 817 is formed.

Even when an abnormality occurs in one of the plurality of unit batteries as a result of the use of the battery module in an abnormal state to cause a necessity of discharging gas generated in the laminate film exterior material to an outside thereof, the separating partition wall cut portion 815 and the intermediate partition wall cut portion 817 function as a gas discharging structure for discharging such gas to make it possible to reduce adverse effect on the adjacent unit battery.

As described above, the unit battery housing 800 has the four unit battery housing spaces: first battery housing chamber 807, second battery housing chamber 808, third battery housing chamber 809, and fourth battery housing chamber 810 on the first surface 801 side, and has the four unit battery housing spaces: fifth battery housing chamber 818, sixth housing chamber 819, seventh battery housing chamber 820, and eighth battery housing chamber 821 on the second surface 812 side. In total, eight unit battery housing chambers are formed on both surfaces. Assuming that one unit battery 100 is housed in one battery housing chamber, up to eight unit batteries 100 can be housed in the unit battery housing 800 according to the present embodiment. In the battery module according to the present invention, the number of the unit batteries 100 that can be housed in the unit battery housing 800 is not limited to this example but may be arbitrary if both surfaces of the unit battery housing 800 are used.

A first connector housing concave portion 824 serving as a space for disposing a first connector 828 for taking out a power from the series-connected unit batteries 100 is provided at one end portion (end portion at which the first and eighth battery housing chambers 807 and 821 are disposed) of the unit battery housing 800.

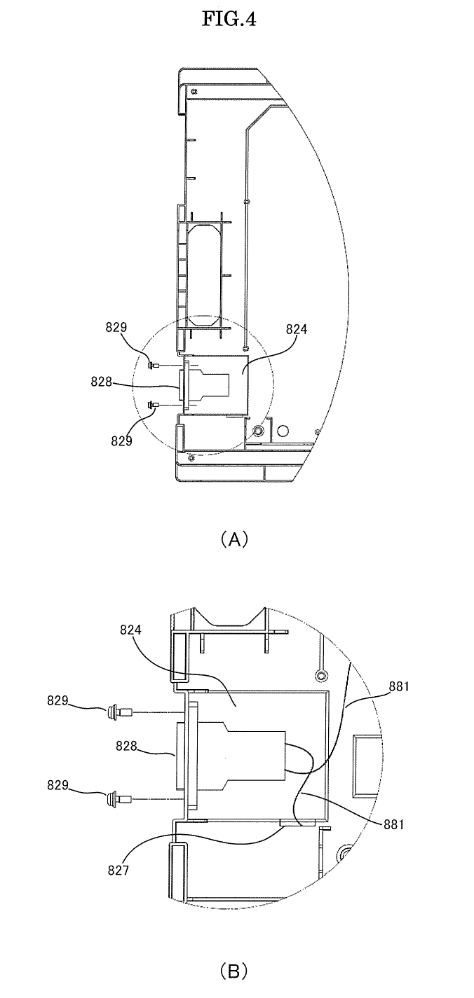

FIGS. 4A and 4B are views explaining mounting of the first connector 828 to the unit battery housing 800. FIG. 4B is an enlarged view of FIG. 4A. The unit battery housing 800 has, in its side wall, a first connector mounting opening portion 825 for mounting of the first connector 828 and a first connector mounting screw holes 826 formed at both sides of the first connector mounting opening portion 825. The first connector 828 is fitted to the first connector mounting opening portion 825, and then a mounting screw 829 is screwed into each of the first connector mounting screw holes 826, whereby the first connector 828 is fixed to the unit battery housing 800. A power supply opening portion 827 penetrating the first surface 801 and a second surface 812 is formed in the vicinity of the first connector housing concave portion 824. This allows a power supply line 881 of the first connector 828 provided on the first surface 801 side to be routed to the second surface 812 side.

A second connector mounting concave portion 832 serving as a space for disposing a second connector 840 for taking out an output from the sense line and a thermistor connecting line from the unit battery 100 is provided at one end portion (end portion at which the fourth and fifth battery housing chambers 810 and 818 are disposed) of the unit battery housing 800.

From the second connector 234, potential information of the tab of each of the series-connected unit battery 100 and temperature information inside the module can be taken out. Based on the potential information of the tab of each unit battery 100, a battery management circuit unit 1100 to be described later can manage each unit battery 100.

When a battery module 1000 is mounted to a power storage device 1200, the battery module 1000 is fitted to a connector (seventh connector 1152 to be described later) positioned deep inside a casing of the power storage device 1200 while being regulated in position by a rail member. At this time, when there is tolerance in the rail member or the like, fitting of the second and seventh connectors is difficult. Thus, the second connector 840 is configured to be slightly displaceable so as to cover such tolerance.

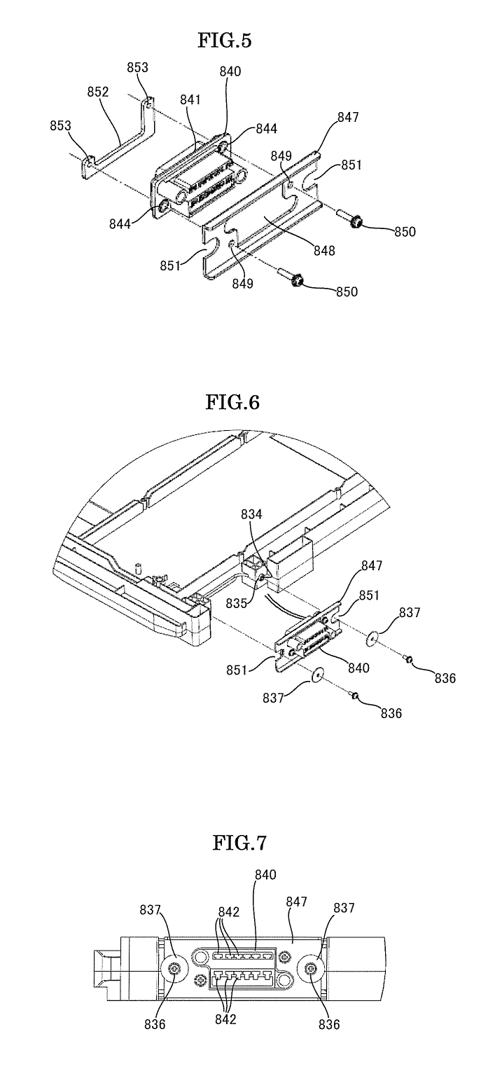

The following describes thus configured second connector 840 based on FIGS. 5 to 7.

FIG. 5 is a view explaining mounting of the second connector 840 to a connector mounting panel 847, FIG. 6 is a view explaining mounting of the connector mounting panel 847 to the unit battery housing 800, and FIG. 7 is a front view of the second connector 840 mounted to the unit battery housing 800.

Two through holes 843 (not illustrated in FIG. 5) are formed at both ends of a main body 841 of the second connector 840 and each fitted with a bush 844. An outer diameter of the bush 844 is smaller by 2Δb than an inner diameter of the through hole 843. This allows the main body 841 of the second connector 840 to be displaced with respect to the bush 844 by 2Δb.

The second connector 840 is fitted to a connector mounting opening 848 of the connector mounting panel 847 and fixed to the connector mounting panel 847 by a mounting screw 850 to be inserted/screwed into a connector mounting screw hole 849, bush 844, and a female screw hole 853 of a fastening member 852. As a result, the second connector 840 can be displaced by 2Δb with respect to the connector mounting panel 847.

A screw hole peripheral projecting portion 835 projects from a plane constituting a panel mounting base 833 of the second connector mounting concave portion 832, and a panel mounting screw hole 834 used for mounting the connector mounting panel 847 to the unit battery housing 800 is formed in a center of the screw hole peripheral projecting portion 835.

An outer diameter of the screw hole peripheral projecting portion 835 inserted through a mounting cut portion 851 formed at both sides of the connector mounting panel 847 is smaller by 2Δa than an inner portion of the mounting cut portion 851, thereby allowing the connector mounting panel 847 to be displaced with respect to the unit battery housing 800 by 2Δa.

The connector mounting panel 847 mounted with the second connector 840 is fixed to the unit battery housing 800 by amounting screw 836 inserted through the connector mounting screw hole 849, a locking washer 837, a mounting cut portion 851, and a panel mounting screw hole 834.

The connector mounting panel 847 can be displaced by 2Δa with respect to the unit battery housing 800, and the second connector 840 can be displaced by 2Δb with respect to the connector mounting panel 847, with the result that the second connector 840 can be displaced by a displacement amount of 2Δa+2Δb with respect to the unit battery housing 800. Here, by setting Δa larger than Δb, the second connector 840 of the battery module 1000 guided by the rail member while being regulated in position is fitted to the seventh connector 1152 more smoothly.

A handle through hole 854 penetrating the first and second surfaces 801 and 812 is provided at one end portion (end portion at which the first and eighth battery housing chambers 807 and 821 are disposed) of the unit battery housing 800. The handle through hole 854 and its surrounding portion function as a handle portion 855. Such handle portion 855 helps improve handleability of the battery module.

A bus bar routing through hole 867 penetrating the first and second surfaces 801 and 812 is formed between the fourth battery housing chamber 810 of the first surface 801 of the unit battery housing 800 and fifth battery housing chamber 818.

In the battery module according to the present invention, the batteries housed in each battery housing chamber are connected in series, and an inter-plane bus bar 877 can be arranged across the fourth battery housing chamber 810 of the first surface 801 and fifth battery housing chamber 818 of the second surface 812 by the bus bar routing through hole 867. As a result, the unit battery 100 housed in the fourth battery housing chamber 810 and unit battery housed in the fifth battery housing chamber 818 can electrically be connected to each other through the inter-plane bus bar 877.

The two unit battery positioning projection 860 are provided in each of the first to eighth battery housing chambers 807 to 821 so as to be vertically installed on the base front surface or base rear surface.

The one unit battery positioning projection 860 in each housing chamber is configured to be fitted into the positioning through hole 124 of the positive electrode lead-out tab 120, and the other unit battery positioning projection 860 is configured to be fitted into the positioning through hole 134 of the negative electrode lead-out tab 130. This allows the unit battery 100 to be quickly positioned and set with respect to the unit battery housing 800, which is effective in terms of production efficiency.

Further, a tab member placement portion 861 is provided in each housing chamber so as to be vertically installed from a plane of the base front surface or base rear surface. The tab member placement portion 861 is provided for keeping the positive electrode lead-out tab 120 of the unit battery 100, negative electrode lead-out tab 130, and bus bar provided between the tabs 120 and 130 spaced apart from the plane by a predetermined distance when the unit battery 100 is set in the unit battery housing 800.

A tab member fixing screw hole 862 is formed in a part of the tab member placement portion 861. Performing screw-fixing by using the tab member fixing screw hole 862 allows: (1) mechanical fixation of the unit battery 100 to the unit battery housing 800; (2) electrical connection of the tab to the bus bar of the unit battery housing; and (3) electrical connection of the tab to the sense line and power supply line. Preferably, the tab member fixing screw hole 862 is obtained by integrally molding and burying a metal cylindrical body whose inner circumference has a screw pattern in the unit battery housing 800 formed of resin.

A cross-like rib structure is provided in a part of the tab member fixing screw hole 862 of the tab member placement portion 861 so as to reinforce the tab member fixing screw hole 862. Further, at a portion where an inter-tab member bus bar 876 is provided so as to bridge the adjacent tab member fixing screw holes 862, an inter-screw hole bridging portion 863 is provided so as to correspond to the inter-tab member bus bar 876, whereby the inter-tab member bus bar 876 can be stably placed between the adjacent tab member fixing screw holes 862. Further, a bus bar positioning projection 864 projects from an upper surface of the inter-screw hole bridging portion 863. By fitting the bus bar positioning projection 864 into a through hole formed in the inter-tab member bus bar 876, the inter-tab member bus bar 876 can easily be set, thereby improving production efficiency.

The positive electrode lead-out tab 120 of the unit battery 100 housed in the first battery housing chamber 807 of the first surface 801 and the negative electrode lead-out tab 130 of the unit battery 100 housed in the eighth battery housing chamber 821 of the second surface 812 are each connected to the power supply line as well as to the sense line and, in order to fix an end portion bus bar 875 used for the connection, an end portion bus bar fixing frame 865 is provided in each of the first and eighth battery housing chambers 807 and 821.

A first end side projecting guide member 870 is provided at one end in an outer periphery of the unit battery housing 800, and a second end side projecting guide member 872 is provided at the other end opposite to the one end. The first end side projecting guide member 870 and second end side projecting guide member 872 each have a structure in which convex portions are continued in a longitudinal direction. Sliding the first end side projecting guide member 870 and the second end side projecting guide member 872 with a concave guide member 1145 of a rail member to be described later allows the battery module 1000 according to the present invention to be housed in a casing of the power storage device 1200.

A tapered portion 871 is provided at both end portions of the first end side projecting guide member 870, and a tapered portion 873 is provided at both end portions of the second end side projecting guide member 872. With this configuration, it is possible to easily insert the battery module 1000 into the concave guide member 1145 of the rail member, thus improving handleability. Further, when the battery module 1000 is removed from the concave guide member 1145 of the rail member, each taper portion serves as an allowance, so that it is not necessary to pay attention to a removal direction of the battery module 1000 so much, thus improving handleability.

By making widths of the first end side projecting guide member 870 and the second end side projecting guide member 872 different from each other, it is possible to prevent the battery module 1000 from being inserted/removed into/from the power storage device in an unexpected attitude. The width of the first end side projecting guide member 870 or width of the second end side projecting guide member 872 can be defined as a length thereof as viewed in a direction perpendicular to the base front surface or base rear surface.

The first end side projecting guide member 870 and the second end side projecting guide member 872 are arranged on respective side surfaces opposite to each other which are different from the base front surface and the base rear surface and along planar directions of the respective base front and base rear surfaces.

The first end side projecting guide member 870 and the second end side projecting guide member 872 may be provided so as to project from the peripheral partition wall portions (802, 813) or to extend from the base. Further, the tapered portion can be said to be a portion varied in the projecting amount or extending amount.

In the unit battery housing 800, the unit battery 100 or various types of wiring disposed on the first surface 801 are covered by a first surface cover body 910, and the unit battery 100 or various types of wiring disposed on the second surface 812 are covered by a second surface cover body 920.

To this end, 16 cover body fixing screw holes 869 for use in screw-fixing the first surface cover body 910 to the first surface 801 by screws are formed in the first surface 801. Similarly, 16 cover body fixing screw holes 869 for use in screw-fixing the second surface cover body 920 to the first surface 220 by screws are formed in the second surface 812. The 16 cover body fixing screw holes 869 are formed in each of the first and second surfaces 801 and 812; however, the screw-fixing need not be performed at all the cover body fixing screw holes 869. Further, the number of the cover body fixing screw holes 869 to be formed in each surface is not limited to 16 but may be arbitrary.

The following describes a process of assembling components such as the unit battery 100 to the thus configured unit battery housing 800 to form the battery module according to the present invention.

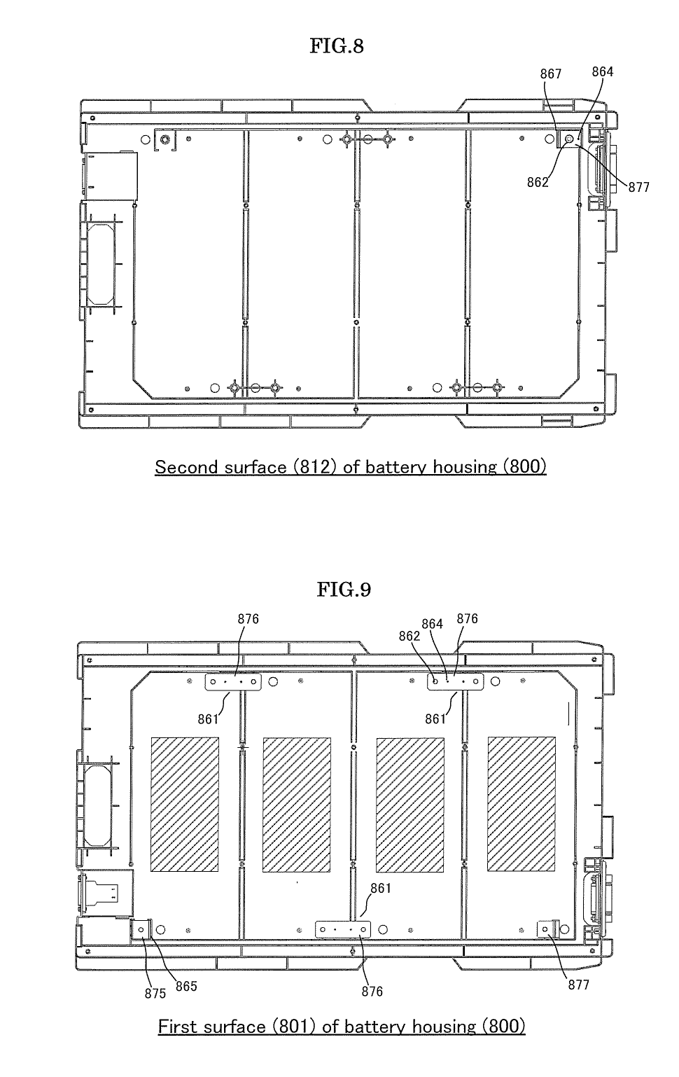

In a process illustrated in FIG. 8, the inter-plane bus bar 877 used for conductive connection between the unit battery 100 housed in the fourth battery housing chamber 810 of the first surface 801 and the unit battery 100 housed in the fifth battery housing chamber 818 of the second surface 812 is set. The inter-plane bus bar 877 is inserted through the bus bar routing through hole 867 to cause the bus bar positioning projection 864 to be fitted into a through hole formed in the inter-plane bus bar 877, whereby mounting of the inter-plane bus bar 877 is completed. A through hole corresponding to the tab member fixing screw hole 862 is also previously formed in the inter-plane bus bar 877.

In a process illustrated in FIG. 9, the bus bar positioning projection 864 is fitted into a through hole formed in the inter-tab member bus bar 876 to thereby set the inter-tab member bus bar 876 on the tab member placement portion 861. A through hole corresponding to the tab member fixing screw hole 862 is also previously formed in the inter-tab member bus bar 876. Further, in this process, the end portion bus bar 875 is set in the end portion bus bar fixing frame 865. A through hole corresponding to the tab member fixing screw hole 862 is also previously formed in the end portion bus bar 875. Further, an adhesive is applied onto a hatched portion of each battery housing chamber.

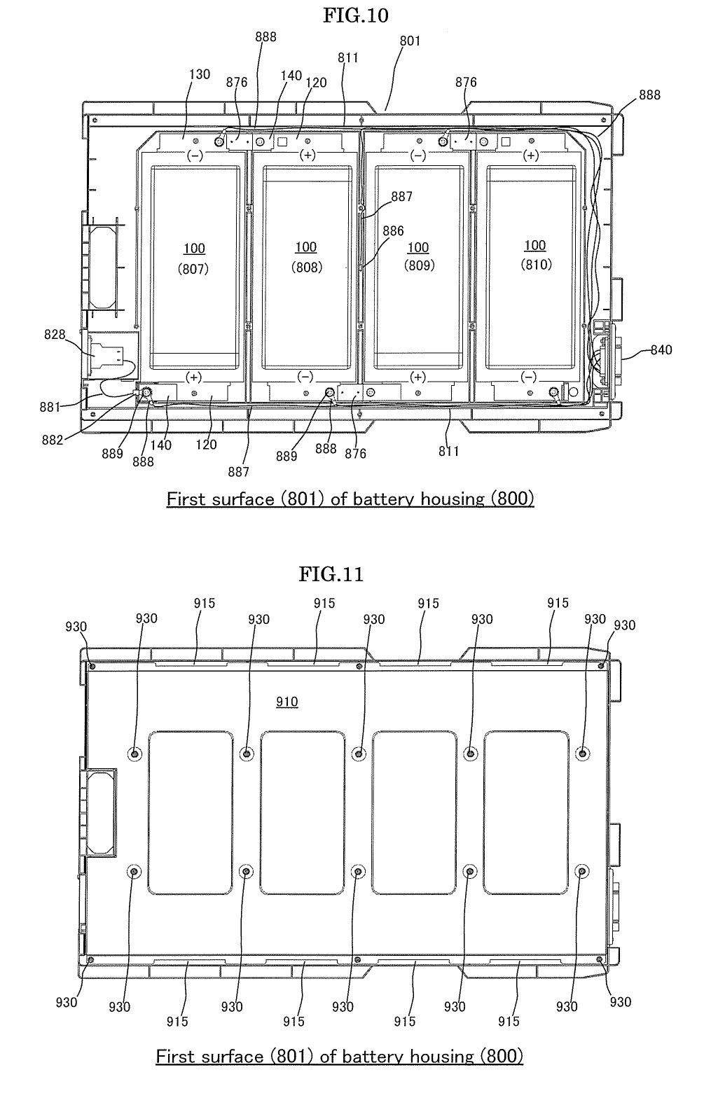

In a process illustrated in FIG. 10, the unit battery 100 is housed in each of the first battery housing chamber 807, second battery housing chamber 808, third battery housing chamber 809, and fourth battery housing chamber 810 onto which the adhesive is applied. At this time, the unit battery positioning projection 860 of the unit battery housing 800 is made to penetrate the positioning through hole 124 of the positive electrode lead-out tab 120 of the unit battery 100 and the positioning through hole 134 of the negative electrode lead-out tab 130. This allows positioning to be easily performed, thus improving production efficiency. In the drawing, (+) is marked to a side at which the positive electrode lead-out tab 120 of the unit battery 100 is drawn, and (−) is marked to a side at which the negative electrode lead-out tab 130 is drawn. As illustrated in FIG. 10, on one end side of the unit battery housing 800, polarities of the tabs of the unit batteries 100 housed in the adjacent battery housing chambers are made different. With this configuration, when the tabs of unit batteries are electrically connected through the inter-tab member bus bar 876, the relevant unit batteries are connected in series.

In the present embodiment, the plurality of unit batteries 100 are arranged in one direction (direction perpendicular to the drawing direction of the lead-out tab of the unit battery 100), and the tabs of the adjacent unit batteries 100 are electrically connected to each other, whereby the series connection of the unit batteries 100 can be easily achieved.

The inter-tab member bus bar 876 and tab of the unit battery 100 are electrically and mechanically fixed to each other by a screw 889 to be inserted into the tab member fixing screw hole 862. Here, a sense line terminal 888 is also fixed to one of two screws 889 for fixing the inter-tab member bus bar 876. The sense line terminal 888 is conductively connected to the second connector 840 by a sense line 887 arranged in the first surface sense line housing portion 811, whereby the potential information of the tab of the unit battery 100 can be output from the second connector 840.

The additional tab member 140 of the unit battery 100 in the first battery housing chamber 807 is electrically and mechanically fixed, by the screw 889, to a power supply line terminal 882, sense line terminal 888, and end portion bus bar 875 on the end portion bus bar 875. The power supply line terminal 882 is conductively connected to the first connector 828 by the power supply line 881, whereby a positive polarity output of the battery module can be taken out from the first connector 828.

Further, a thermistor 886 for monitoring temperature of the battery module 1000 is provided between the two first surface separating partition wall portions 803 positioned between the second battery housing chamber 808 and the third battery housing chamber 809. The thermistor 886 and the second connector 840 are conductively connected to each other by a thermistor connecting line 885, whereby the temperature information can be output from the second connector 840.

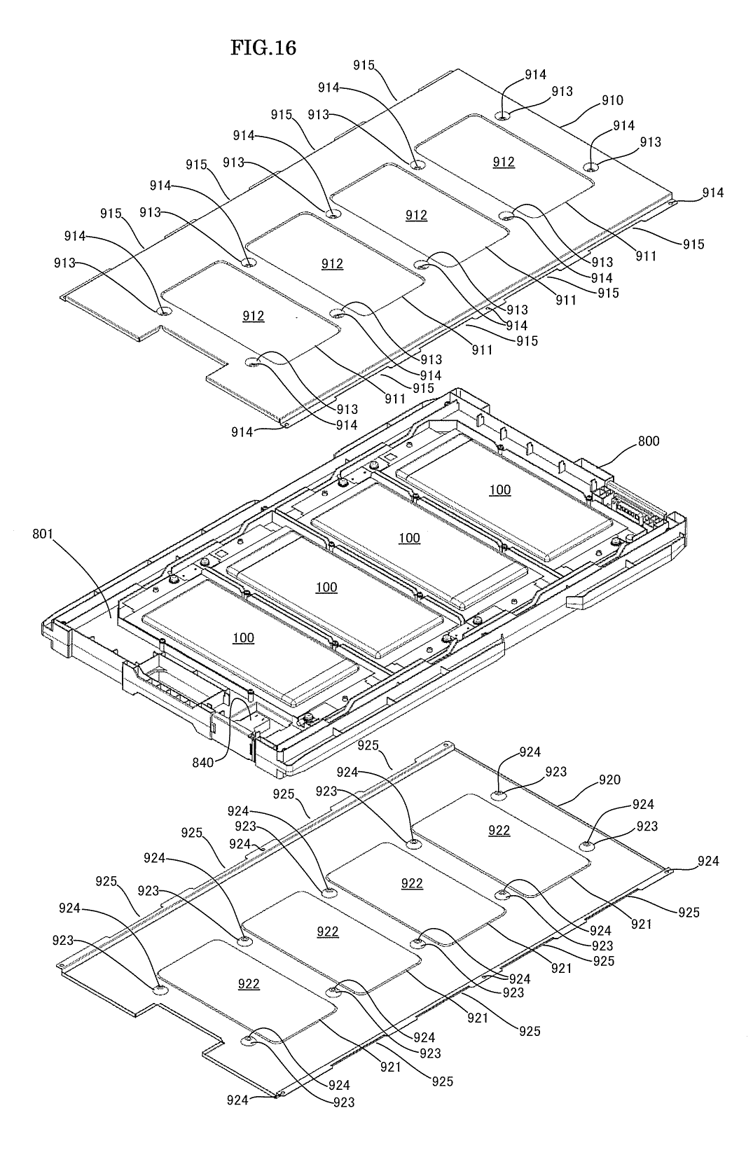

In a process illustrated in FIG. 11, the first surface cover body 910 is fixed, by screws 930, to the first surface 801 of the unit battery housing 800. Here, with reference to a perspective view of FIG. 16, the first surface cover body 910 will be described. The first surface cover body 910 and the second surface cover body 920 have the same configuration except that they have a mirror-symmetrical relationship, so only the first surface cover body 910 will be described.

The first surface cover body 910 is an aluminum cover member for shielding the unit battery 100, power supply line 881, sense line 887, thermistor 886, and the like housed on the first surface 801 of the unit battery housing 800.

The first surface cover body 910 is subjected to drawing, i.e., has a battery pressing drawn portion 911 that presses the unit battery 100 housed in each battery housing chamber when the first surface cover body 910 is fixed to the first surface 801. Further, a surface that presses the unit battery 100, which is formed by the battery pressing drawn portion 911, is defined as a pressing surface 912. The pressing surface 912 formed by the battery pressing drawn portion 911 presses an electrode laminated area 105 of the unit battery 100 upon attachment of the first surface cover body 910 to thereby restrain expansion or the like of the unit battery 100 due to long time use of the unit battery 100, thereby increasing the life of the unit battery 100.

Further, screw holes 914 are formed in the first surface cover body 910 at positions corresponding to the cover body fixing screw holes 869 in a state where the first surface cover body 910 is fixed to the first surface 801. A screw hole drawn portion 913 is formed around the screw hole 914, whereby the first surface cover body 910 is fixed to the first surface 801 with a part of the first surface cover body 910 around the screw hole 914 brought into close contact with the first surface 801.

Further, a cut portion 915 is formed in the first surface cover body 910 so as to correspond to the lead-out tab of the unit battery 100 in a state where the first surface cover body 910 is fixed to the unit battery housing 800. Forming such a cut portion 915 allows exhaust performance of the battery module 1000 to be ensured.

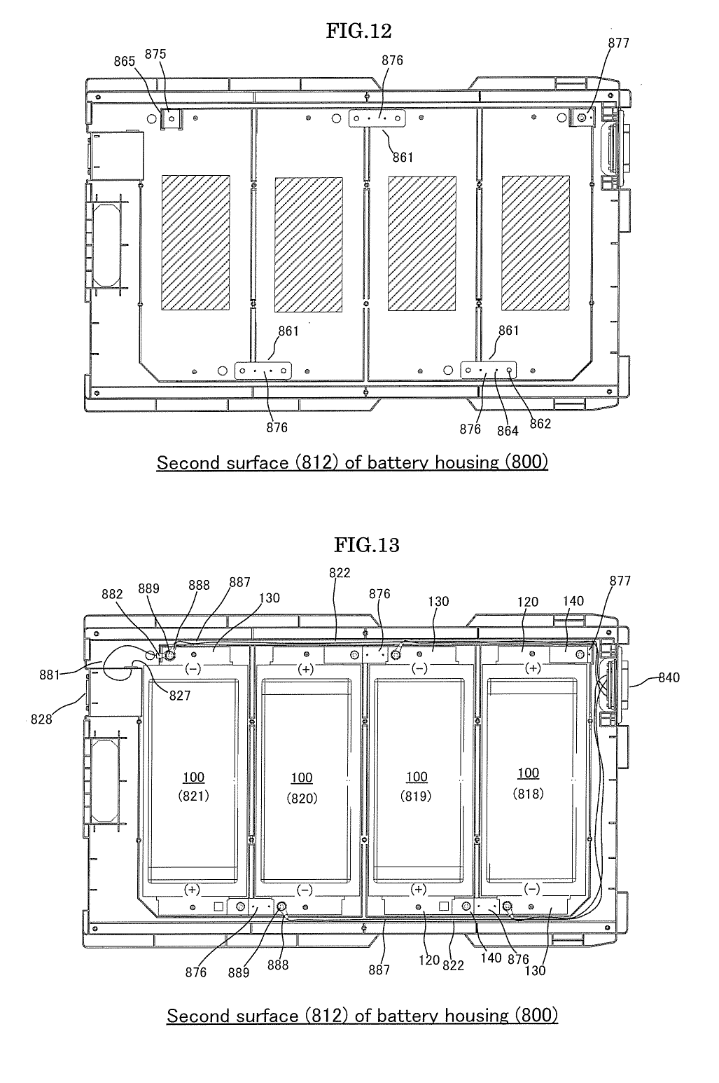

In a process illustrated in FIG. 12, on the second surface 812 of the unit battery housing 800, the bus bar positioning projection 864 is fitted into a through hole formed in the inter-tab member bus bar 876 to thereby set the inter-tab member bus bar 876 on the tab member placement portion 861. A through hole corresponding to the tab member fixing screw hole 862 is also previously formed in the inter-tab member bus bar 876. Further, in this process, the end portion bus bar 875 is set in the end portion bus bar fixing frame 865. A through hole corresponding to the tab member fixing screw hole 862 is also previously formed in the end portion bus bar 875. Further, an adhesive is applied onto a hatched portion of each battery housing chamber.

In a process illustrated in FIG. 13, on the second surface 812 of the unit battery housing 800, the unit battery 100 is housed in each of the fifth battery housing chamber 818, sixth battery housing chamber 819, seventh battery housing chamber 820, and eighth battery housing chamber 821 onto which the adhesive is applied. At this time, the unit battery positioning projection 860 of the unit battery housing 800 is made to penetrate the positioning through hole 124 of the positive electrode lead-out tab 120 of the unit battery 100 and the positioning through hole 134 of the negative electrode lead-out tab 130. This allows positioning to be easily performed, thus improving production efficiency. In the drawing, (+) is marked to a side at which the positive electrode lead-out tab 120 of the unit battery 100 is drawn, and (−) is marked to a side at which the negative electrode lead-out tab 130 is drawn. As illustrated in FIG. 13, on one end side of the unit battery housing 800, polarities of the tabs of the unit batteries 100 housed in the adjacent battery housing chambers are made different. With this configuration, when the tabs of unit batteries are electrically connected through the inter-tab member bus bar 876, the relevant unit batteries are connected in series.

In the present embodiment, the plurality of unit batteries 100 are arranged in one direction (direction perpendicular to the drawing direction of the lead-out tab of the unit battery 100), and the tabs of the adjacent unit batteries 100 are electrically connected to each other, whereby the series connection of the unit batteries 100 can be easily achieved.

The inter-tab member bus bar 876 and tab of the unit battery 100 are electrically and mechanically fixed to each other by the screw 889 to be inserted into the tab member fixing screw hole 862. Here, the sense line terminal 888 is also fixed to one of two screws 889 for fixing the inter-tab member bus bar 876. The sense line terminal 888 is conductively connected to the second connector 840 by the sense line 887 arranged in the first surface sense line housing portion 811, whereby the potential information of the tab of the unit battery 100 can be output from the second connector 840.

The negative electrode lead-out tab 130 of the unit battery 100 in the eighth battery housing chamber 821 is electrically and mechanically fixed, by the screw 889, to the power supply line terminal 882, sense line terminal 888, and end portion bus bar 875 on the end portion bus bar 875. The power supply line terminal 882 is conductively connected to the first connector 828 by the power supply line 881, whereby a negative polarity output of the battery module can be taken out from the first connector 828.

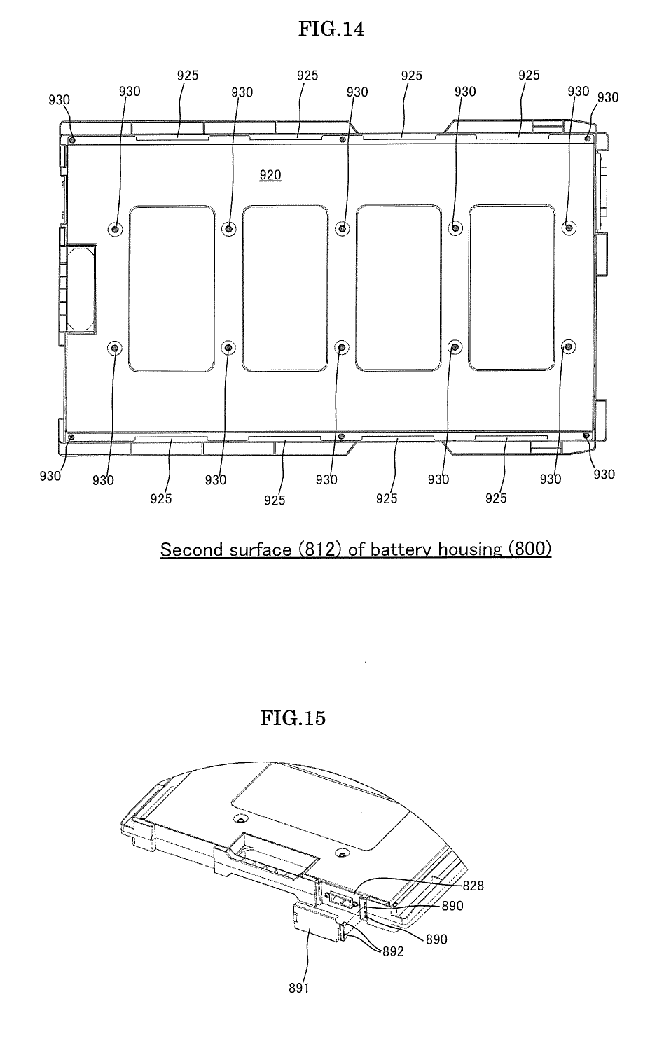

In a process illustrated in FIG. 14, the second surface cover body 920 is fixed, by screws 930, to the second surface 812 of the unit battery housing 800.

In a process illustrated in FIG. 15, a cap member 891 is attached to the first connector 828. Voltage corresponding to eight series-connected unit batteries 100 is applied to a conductive terminal of the first connector 828. Thus, in order to secure safety in handling the battery module 1000, such a cap member 891 is used to shield the first connector 828. The cap member 891 has two locking pieces 892. By inserting the two locking pieces 892 into two locking ports 890 which are formed in a side wall portion of the unit battery housing 800 so as to correspond to the two locking pieces 892, the cap member 891 can be attached to the first connector 828 so as to cover the same. The cap member 891 is removed when the battery module 1000 is mounted to the power storage device 1200.

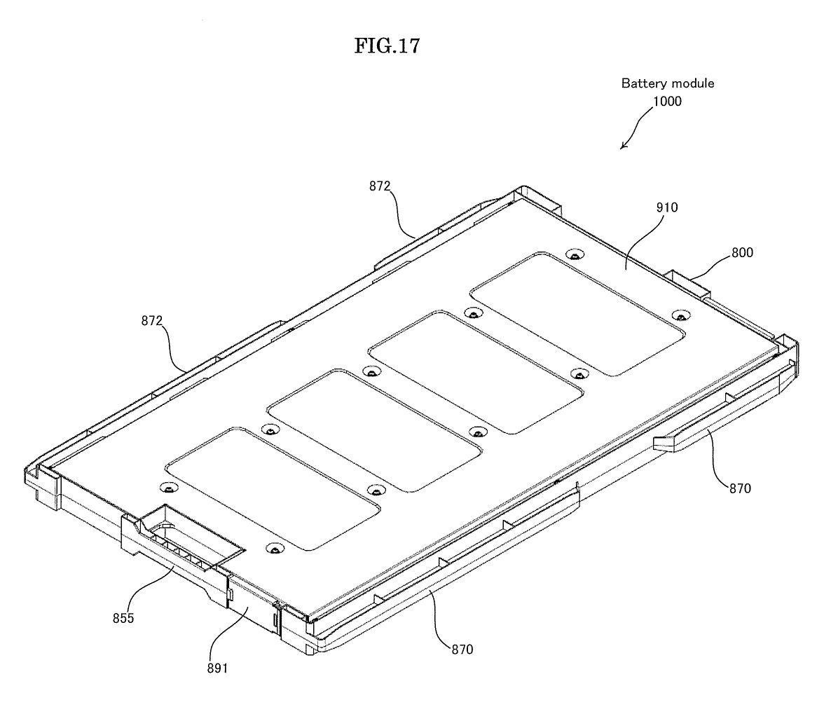

Through the above-described processes, the battery module 1000 as illustrated in a perspective view of FIG. 17 is completed.

The following describes impact resistance of the thus configured battery module 1000 according to the present embodiment. The battery module 1000 according to the present embodiment is designed to withstand an impact of at least G [N/kg]. A concrete method for realizing this will be described.

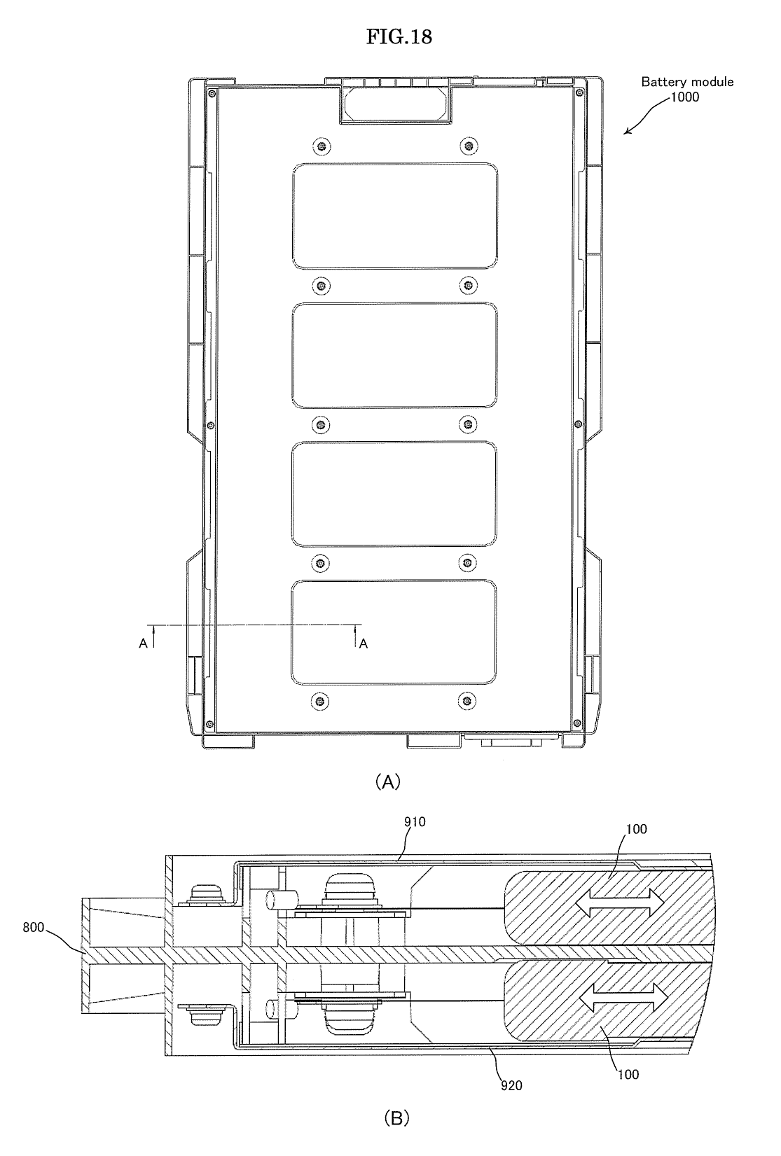

First, with reference to FIG. 18, problems caused when impact or vibration is applied to the battery module 1000 incorporating the unit battery in which the electrode laminate is encapsulated by the laminate film exterior material will be described.

FIGS. 18A and 18B are views each explaining an internal structure of the battery module 1000 according to the embodiment of the present invention. FIG. 18A is a plan view of the battery module 1000, and FIG. 18B is a cross-sectional view taken along a line A-A of FIG. 18A. The cross-sectional view is obtained by cutting a substantial center of the lead-put tab of the unit battery 100 housed in the battery housing 800 in a width direction thereof.

In the battery module 1000, the electrode laminate provided in the laminate film exterior material is designed to be slightly displaced due to impact or vibration as indicated by an arrow of FIG. 18B even though the unit battery 100 is fixed to the unit battery housing 800 and the first surface cover body 910 (or second surface cover body 920). Thus, a long-time vibration or impact is applied to the battery module, the electrode laminate acts as a pendulum, which may cause breakage of the laminate film exterior material and leakage of electrolyte due to the breakage, cause rupture of a collector conductively connecting the electrode laminate and lead-out tab, or cause rupture of the lead-out tab.

To cope with this, in the battery module 1000 according to the present embodiment, parameters are set so as to prevent the electrode laminate from being displaced due to impact or vibration.

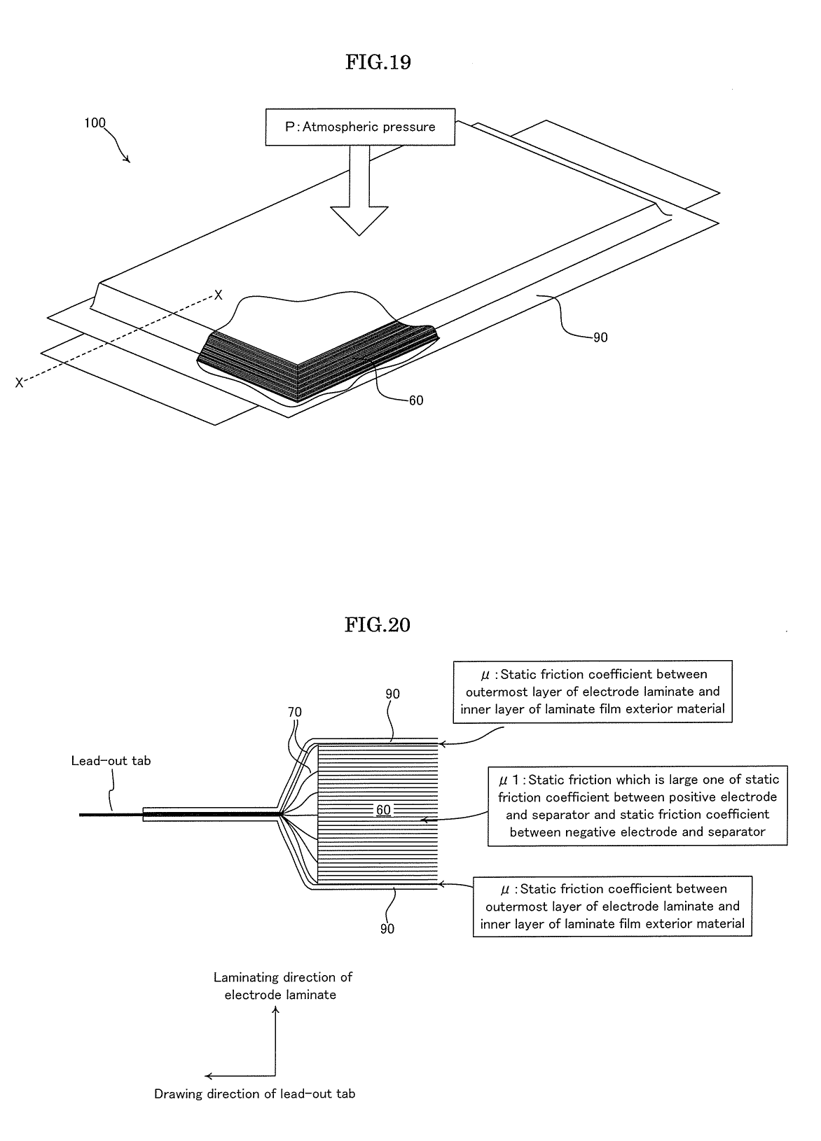

FIG. 19 is a view explaining an internal structure of the unit battery 100 and atmospheric pressure applied to the unit battery 100. In FIG. 19, the collector is omitted, and the laminate film exterior material 90 is illustrated in a partially transparent manner. As illustrated in FIG. 19, an atmospheric pressure P [Pa] is applied to the laminate film exterior material 90, and the atmospheric pressure P [Pa] influences calculation of a friction force between the outermost layer of the electrode laminate 60 and an inner layer of the laminate film exterior material 90.

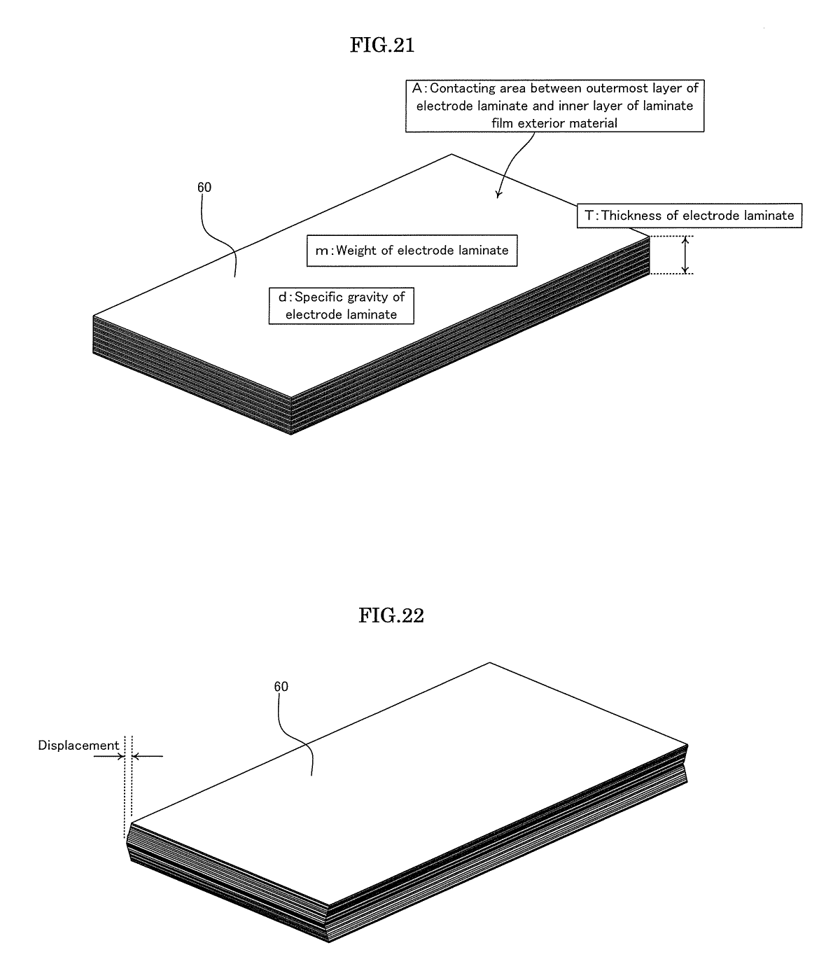

FIG. 20 is a cross-sectional view taken along a line X-X′ of FIG. 19, which explains a static friction coefficient in the unit battery 100. FIG. 21 is a view explaining parameters related to the electrode laminate 60, which illustrates only the electrode laminate 60 of the unit battery 100.

The battery body 110 of the unit battery 100 has a structure in which the electrode laminate 60 obtained by laminating the plurality of sheet-like positive electrodes and plurality of sheet-like negative electrodes through the separators and electrolyte (not illustrated) are housed in the laminate film exterior material 90 having a rectangular shape in a plan view.

As illustrated in FIG. 20, a static friction coefficient between the outermost layer of the electrode laminate 60 and the inner layer of the laminate film exterior material 90 is defined as μ, and a larger one of a static friction coefficient between the positive electrode and the separator and that between the negative electrode and the separator is defined as μ1.

The static friction coefficient μ between the outermost layer of the electrode laminate 60 and the inner layer of the laminate film exterior material 90 may be changed as needed by applying predetermined processing to the outermost layer of the electrode laminate 60 or inner layer of the laminate film exterior material 90. That is, it is possible to adjust the static friction coefficient μ by using such processing.

Further, as illustrated in FIG. 21, a weight of the electrode laminate 60 is defined as m [kg], a contacting area (area of an end surface of the electrode laminate 60 in the laminating direction) between the outermost layer of the electrode laminate 60 and the inner layer of the laminate film exterior material 90 is defined as A [m²], a thickness of the electrode laminate 60 is T [m], and a specific gravity of the electrode laminate 60 is defined as d [g/cm³].

The electrolyte is poured in the laminate film exterior material 90, so that the static friction coefficient between the outermost layer of the electrode laminate 60 and the inner layer of the laminate film exterior material 90 is smaller than that in a state where the electrolyte is not present.

Here, the static friction coefficient between the outermost layer of the electrode laminate 60 and the inner layer of the laminate film exterior material 90 in a state where the electrolyte is poured in the laminate film exterior material 90 is defined as an effective static friction coefficient μ_{eff}. When a predetermined coefficient is e (e is a positive value less than 1) the effective static friction coefficient μ_{eff} can be calculated based on μ_{eff}=eμ.

Although the value of e varies depending on a type or amount of the electrolyte encapsulated in the laminate film exterior material 90, it generally assumes a value in a range of 0.11≦e≦0.12 when the unit battery 100 is a lithium ion secondary battery.

Under such definitions, in the present invention, as a relationship that the static friction coefficient should satisfy, a relationship of μ_{ef f}<μ1 is established between the effective static friction coefficient μ_{eff} between the outermost layer of the electrode laminate 60 and the inner layer of the laminate film exterior material 90 in a state where the electrolyte is filled in the laminate film exterior material and the static friction coefficient μ1 which is a larger one of the static friction coefficient between the positive electrode and the separator and that between the negative electrode and the separator.

This is because the positive electrode, negative electrode, and the separator in the electrode laminate 60 may be displaced as illustrated in FIG. 22 due to application of impact or vibration if the relationship of μ_{eff}<μ1 is not satisfied.

The following describes a condition for the electrode laminate 60 itself not to be displaced as a bulk. Assuming that an impact value that the battery module 1000 can withstand is G, a force F1 to be applied to the electrode laminate 60 is mG at most.

On the other hand, a maximum static friction force F2 of the electrode laminate 60 can be represented as 2PAμ_{eff}, since two upper and lower surfaces of the electrode laminate 60 are counted.

A condition under which the electrode laminate 60 itself is not moved even when the impact G is applied to the battery module 1000 is F1<F2. By assigning the 2PAμ_{eff} to this condition, a relationship of mG<2PAμ_{eff} can be derived.

As described above, according to the battery module 1000 of the present invention, the relationship of mG<2PAμ_{eff} which is a condition under which the electrode laminate 60 itself is not moved even when the impact G is applied to the battery module 1000 is established. Thus, it is possible to provide the battery module 1000 having excellent vibration resistance/impact resistance, and thus capable of reducing probability of occurrence of breakage of the laminate film exterior material 90 and leakage of electrolyte due to the breakage, occurrence of rupture of a collector conductively connecting the electrode laminate and lead-out tab, or occurrence of rupture of the lead-out tab even when a long-time vibration or impact is applied to the battery module 1000.

Further, a relationship of m=TAd×10³ is established between the specific gravity d and a volume (T×A) of the electrode laminate 60. By assigning m=TAd×10³ to mG<²PAμ_{eff}, a relationship of T<2PAμ_{eff}/10³ dG can be obtained.

By satisfying the T<2PAμ_{eff}/10³ dG, it is possible to provide the battery module 1000 capable of preventing the electrode laminate 60 itself of the battery module 1000 from being moved by the impact G.

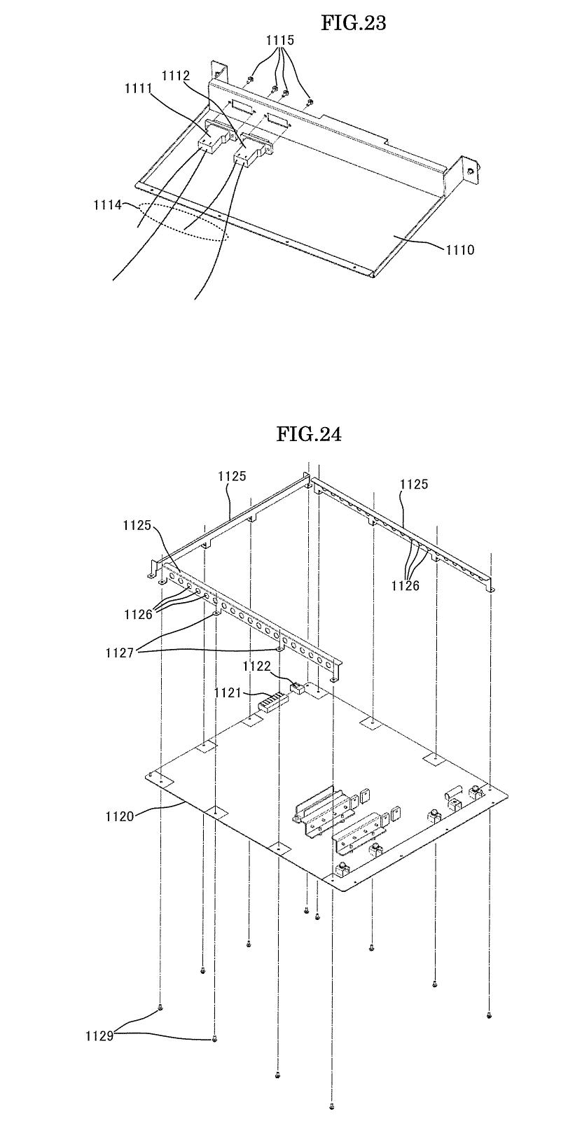

The following describes an overview of a configuration of a battery management circuit unit 1100 that manages the above-described battery module 1000 according to the present invention. FIGS. 23, 24, and 25 are views each explaining a production process of the battery management circuit unit 1100. FIG. 26 is a view illustrating the battery management circuit unit 1100.

In a process illustrated in FIG. 23, a third connector 1111 and a fourth connector 1112 are attached by screws 1115 to a connector panel 1110. Considering mountability to the power storage device 1200, the battery management circuit unit 1100 preferably has substantially the same size as that of the battery module 1000; however, when the above-described dimension is attempted to be achieved only by a circuit substrate 1120, required cost is increased. Thus, the connector panel 1110 is used.

In a process illustrated in FIG. 24, a side plate 1125 partially having ventilation holes 1126 for cooling of the circuit is fixed to the circuit substrate 1120 on which a battery management circuit is mounted, by screws 1129 to be inserted through screw hole portions 1127 of the circuit substrate 1120.

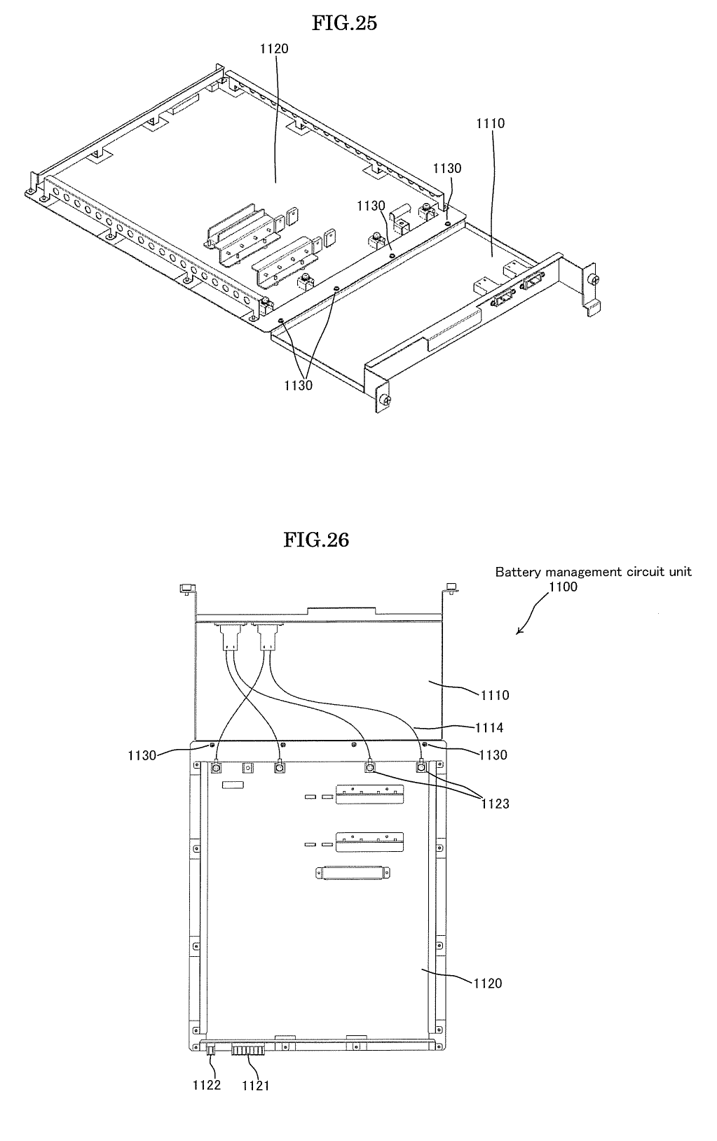

In a process illustrated in FIG. 25, the circuit substrate 1120 and the connector panel 1110 are fixed to each other by screws 1130.

In a process illustrated in FIG. 26, lead wires 1114 of the respective third and fourth connectors 1111 and 1112 provided in the connector panel 1110 are electrically connected to terminals 1123 of the circuit substrate 1120.

The thus configured battery management circuit unit 1100 has third, fourth, fifth, and sixth connectors 1111, 1112, 1121, and 1122.

The following describes the power storage device 1200 constituted by the thus configured battery management circuit unit 1100 and the battery module 1000.

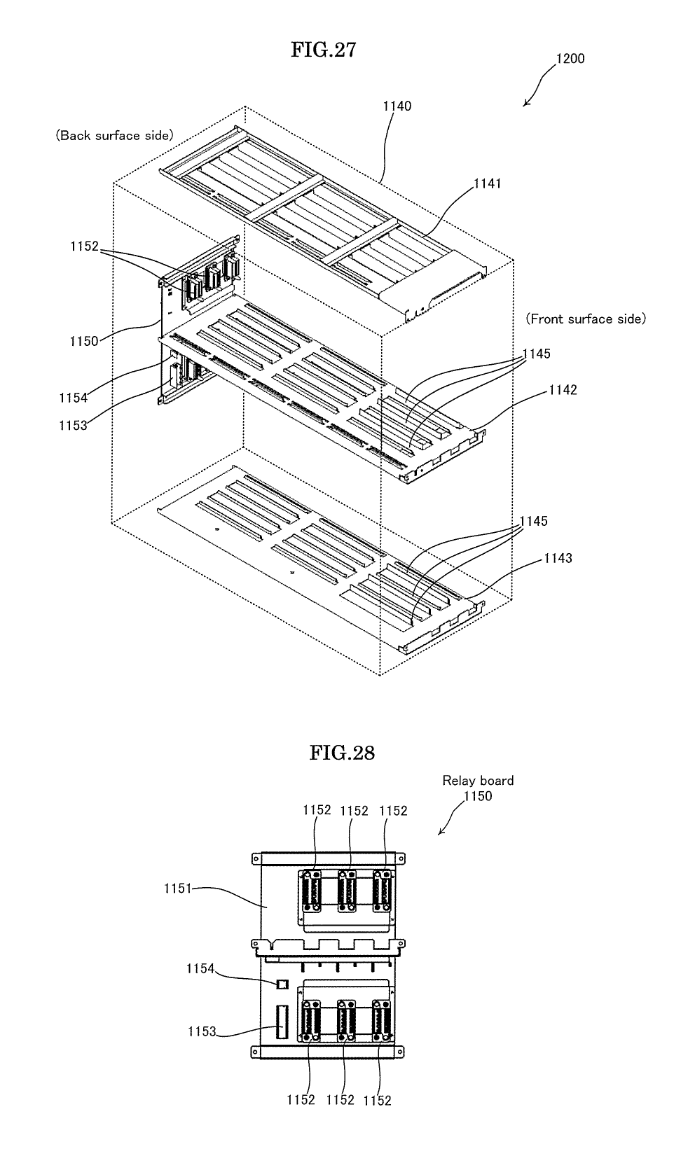

FIG. 27 illustrates a casing 1140 of the power storage device 1200 using the battery module 1000 according to the present invention. As illustrated, an upper rail member 1141, an intermediate rail member 1142, and a lower rail member 1143 are provided inside the casing 1140. The concave guide members 1145 for use in slidably setting the battery module 1000 to the power storage device 1200 are formed respectively on a lower surface of the upper rail member 1141, upper and lower surfaces of the intermediate rail member 1142, and an upper surface of the lower rail member 1143.

Further, a relay board 1150 is provided at a back surface side of the casing 1140 of the power storage device 1200. FIG. 28 is a view illustrating the relay board 1150 as viewed from the front of the power storage device 1200. The relay board 1150 has a seventh connector 1152 to which the second connector 840 of each battery module 1000 is fitted and eighth and ninth connectors 1153 and 1154 to which the fifth and sixth connectors 1121 and 1122 of the battery management circuit unit 1100 are fitted, respectively. In addition, although not illustrated, wiring is arranged in the relay board 1150, whereby the sense information and temperature information of each battery module 1000 can be relayed to the battery management circuit unit 1100. Thus, the battery management circuit unit 1100 acquires the potential data of each unit battery 100 and temperature data in each battery module 1000 and performs control, such as discharge stop, based on the acquired data.

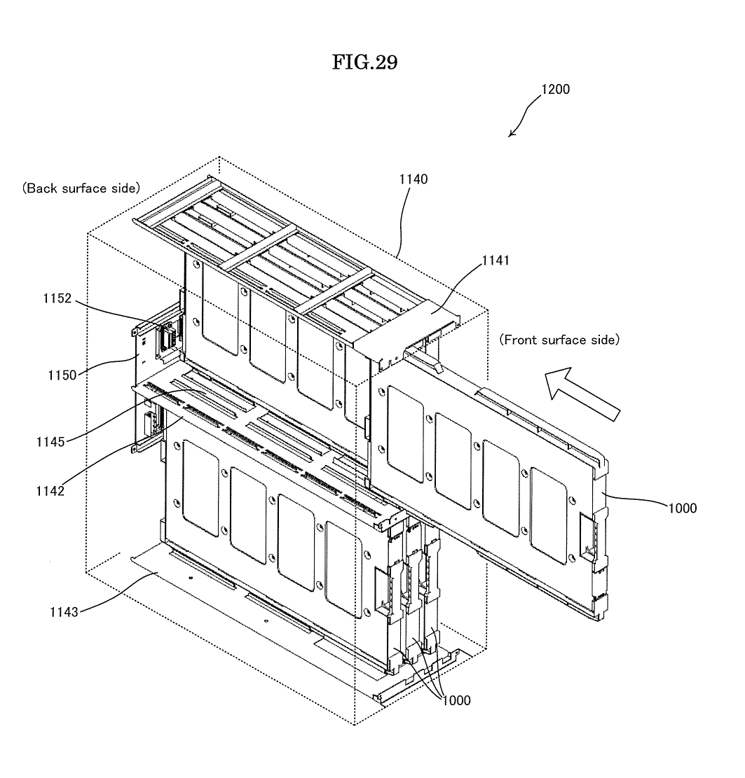

FIG. 29 illustrates a state where the battery module 1000 is slid along the concave guide member 1145 of the rail member to be set to the casing 1140 of the power storage device 1200. At this time, the second connector 840 of the battery module 1000 needs to be fitted to the seventh connector 1152 of the relay board 1150 provided at the back surface side of the casing 1140.

When there is tolerance in the rail member or the like, fitting of the second connector 840 and the seventh connector 1152 is difficult. Thus, the second connector 840 is configured to be slightly displaceable so as to cover such tolerance.

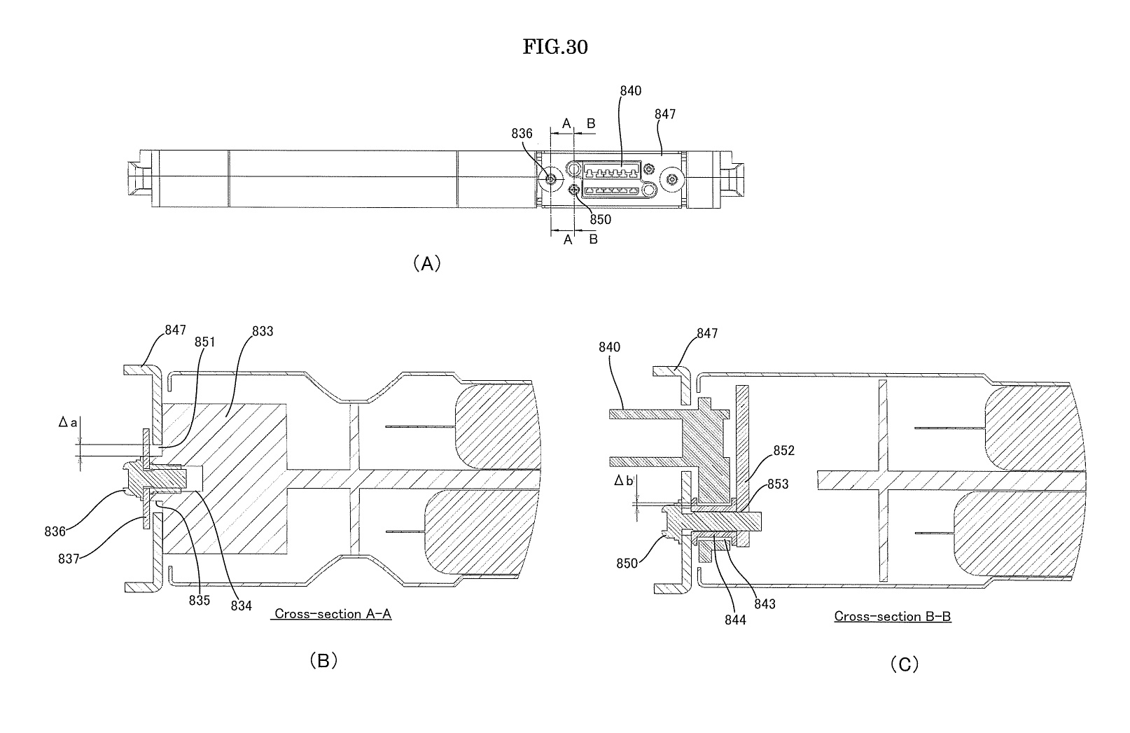

The following describes a configuration for enabling such displacement. FIGS. 30A to 30C are views each explaining a configuration around the second connector 840 of the battery module 1000 according to the embodiment of the present invention. FIG. 30A is a view illustrating the second connector 840 of the battery module 1000 as viewed from the front, FIG. 30B is a cross-sectional view taken along a liner A-A of FIG. 30A, and FIG. 30C is a cross-sectional view taken along a liner B-B of FIG. 30A.

As illustrated in FIG. 30B, the screw hole peripheral projecting portion 835 projects from the plane constituting the panel mounting base 833 of the unit battery housing 800. The panel mounting screw hole 834 used for mounting the connector mounting panel 847 to the unit battery housing 800 is formed in the center of the screw hole peripheral projecting portion 835.

The outer diameter of the screw hole peripheral projecting portion 835 inserted through the mounting cut portion 851 formed at both sides of the connector mounting panel 847 is smaller by 2Δa than the inner portion of the mounting cut portion 851, thereby allowing the connector mounting panel 847 to be displaced with respect to the unit battery housing 800 by 2Δa.

Further, as illustrated in FIG. 30C, the through hole 843 is fitted with the bush 844. The outer diameter of the bush 844 is smaller by 2Δb than the inner diameter of the through hole 843. This allows the main body 841 of the second connector 840 to be displaced with respect to the bush 844 by 2Δb.

The connector mounting panel 847 can be displaced with respect to the unit battery housing 800 by 2Δa, and further, the second connector 840 can be displaced with respect to the connector mounting panel 847 by 2Δb, so that the second connector 840 can be displaced by a displacement amount of 2Δa+2Δb with respect to the unit battery housing 800.

Here, it is preferable to establish a dimensional relationship of Δa>Δb. The second connector 840 of the battery module 1000 guided by the rail member while being regulated in position is roughly positioned with respect to the seventh connector 1152 by a tolerance of 2Δa and is then fitted to the seventh connector 1152 with a tolerance 2Δb. Thus, by setting Δa larger than Δb, the second connector 840 can be fitted to the seventh connector 1152 more smoothly.

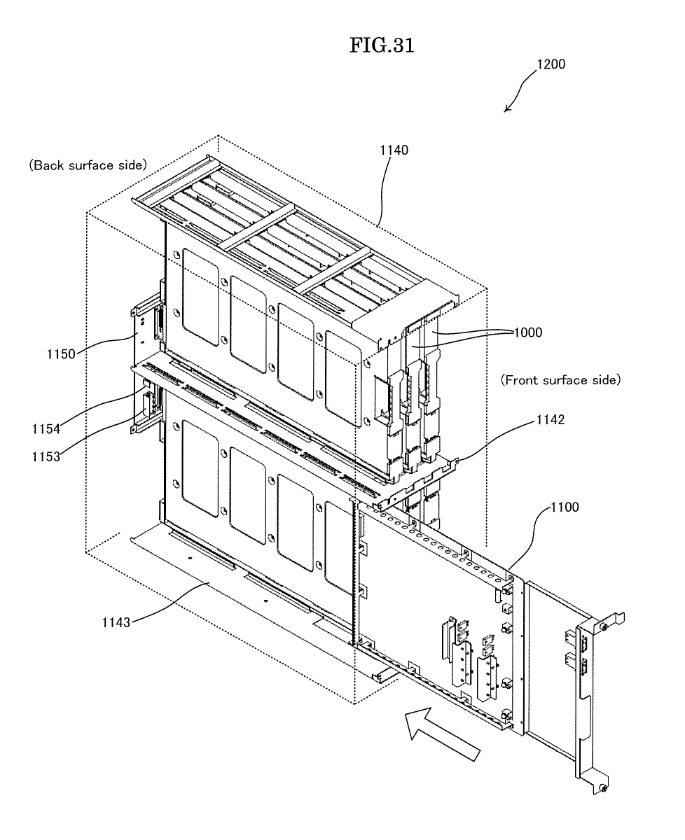

FIG. 31 illustrates a state where the battery management circuit unit 1100 is set to the casing 1140 of the power storage device 1200. The fifth and sixth connectors 1121 and 1122 of the battery management circuit unit 1100 are fitted, respectively, to the eighth and ninth connectors 1153 and 1154 of the relay board 1150.

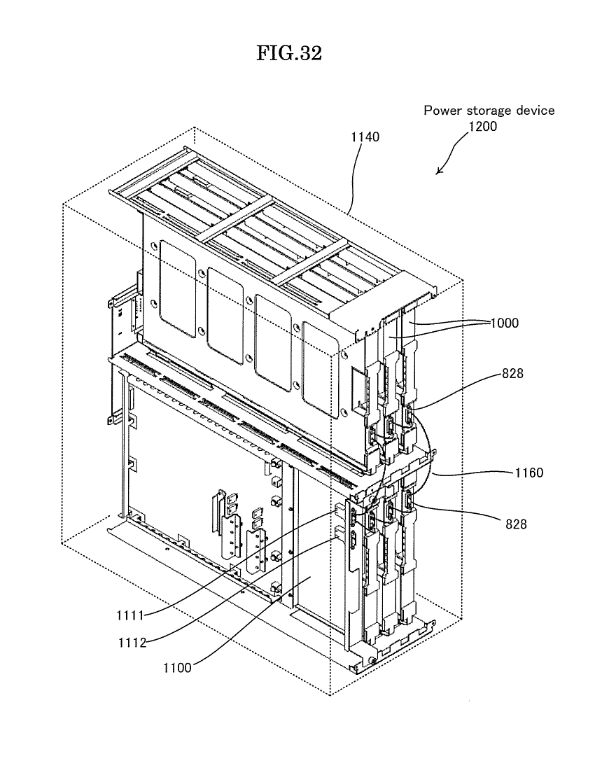

In a process illustrated in FIG. 32, the cap member 891 of each battery module 1000 is removed, and the battery modules 1000 are connected in series by power supply lines 1160. The power supply line 1160 whose one end is connected to an end of the series-connected battery modules is connected, at the other end thereof, to the third connector 1111 of the battery management circuit unit 1100.

By setting the battery modules 1000 and the battery management circuit unit 1100 in the manner as described above, the power storage device 1200 is assembled.

### INDUSTRIAL APPLICABILITY

The present invention relates to a battery module constructed using a lithium ion battery, etc., application of which is being rapidly expanded in the field of power storage devices for clean energy. In a battery module in which the laminate battery is incorporated in a casing, an electrode laminate provided in a laminate film is designed to be slightly displaced even though a unit battery is fixed inside the casing. Thus, when a long-time vibration or impact is applied to the battery module, the electrode laminate acts as a pendulum, which may cause breakage of the laminate film and leakage of electrolyte due to the breakage, cause rupture of a collector conductively connecting the electrode laminate and lead-out tab, or cause rupture of the lead-out tab. On the other hand, according to the battery module of the present invention, the relationship of mG<2PAμ_{eff} which is a condition under which the electrode laminate 60 itself is not moved even when the impact G is applied to the battery module 1000 is established. Thus, it is possible to provide the battery module having excellent vibration resistance/impact resistance, and thus capable of reducing probability of occurrence of breakage of the laminate film exterior material and leakage of electrolyte due to the breakage, occurrence of rupture of a collector conductively connecting the electrode laminate and lead-out tab, or occurrence of rupture of the lead-out tab even when a long-time vibration or impact is applied to the battery module, thus providing high industrial applicability.

### REFERENCE SIGNS LIST

60: Electrode laminate
70: Collector
90: Laminate film exterior material
100: Unit battery
105: Electrode laminated area
110: Battery body
111: Positioning through hole
115: Insulating tape
120: Positive electrode lead-out tab
124: Positioning through hole
130: Negative electrode lead-out tab
134: Positioning through hole
135: Through hole
140: Additional tab member
143: Welding portion
145: Through hole
150: Double-sided tape
800: Unit battery housing
801: First surface
802: First surface peripheral partition wall portion
803: First separating partition wall portion
804: Separating partition wall cut portion
805: First surface intermediate partition wall portion
806: Intermediate partition wall cut portion
807: First battery housing chamber
808: second battery housing chamber
809: Third battery housing chamber
810: Fourth battery housing chamber
811: First surface sense line housing portion
812: Second surface
813: Second surface peripheral partition wall portion
814: Second surface separating partition wall portion
815: Separating partition wall cut portion
816: Second surface intermediate partition wall portion
817: Intermediate partition wall cut portion
818: Fifth battery housing chamber
819: Sixth battery housing chamber
820: Seventh battery housing chamber
821: Eighth battery housing chamber
822: Second surface sense line housing portion
824: First connector housing concave portion
825: First connector mounting opening portion
826: First connector mounting screw hole
827: Power supply line opening portion
828: First connector
829: Mounting screw
832: Second connector mounting concave portion
833: Panel mounting base
834: Panel mounting screw hole
835: Screw hole peripheral projecting portion
836: Mounting screw
837: Locking washer
840: Second connector
841: Main body
842: Metal terminal portion
843: Through hole
844: Bush
847: Connector mounting panel
848: Connector mounting opening portion
849: Connector mounting screw hole
850: Mounting screw
851: Mounting cut portion
852: Fastening member
853: Female screw hole
854: Handle through hole
855: Handle portion
860: Unit battery positioning projection
861: Tab member placement portion
862: Tab member fixing screw hole
863: Inter-screw hole bridging portion
864: Bus bar positioning projection
865: End portion bus bar fixing frame
867: Bus bar routing through hole
869: Cover body fixing screw hole
870: First end side projecting guide member
871: Tapered portion
872: Second end side projecting guide member
873: Tapered portion
875: End portion bus bar
876: Inter-tab member bus bar
877: Inter-plane bus bar
881: Power supply line
882: Power supply line terminal
883: Screw
885: Thermistor connecting line
886: Thermistor
887: Sense line
888: Sense line terminal
889: Screw
890: Locking port
891: Cap member
892: Locking piece
910: First surface cover body
911: Battery pressing drawn portion
912: Pressing surface
913: Screw hole drawn portion
914: Screw hole
915: Cut portion
920: Second surface cover body
921: Battery pressing drawn portion
922: Pressing surface
923: Screw hole drawn portion
924: Screw hole
925: Cut portion
930: Screw
1000: Battery module
1100: Battery management circuit unit
1110: Connector panel
1111: Third connector
1112: Fourth connector
1114: Lead wire
1115: Screw
1120: Circuit substrate
1121: Fifth connector
1122: Sixth connector
1123: Terminal
1125: Side plate
1126: Ventilation hole
1127: Screw hole portion
1129: Screw
1130: Screw
1140: Casing
1141: Upper rail member
1142: Intermediate rail member
1143: Lower rail member
1145: Concave guide member
1150: Relay board
1151: Base material
1152: Seventh connector
1153: Eighth connector
1154: Ninth connector
1160: Power supply line 1200: Power storage device

1-5. (canceled)

6. A battery module constructed by an electrode laminate obtained by laminating positive and negative electrodes through separators and a laminate film exterior material housing the electrode laminate and electrolyte and having an impact resistance against an impact of at least G [N/kg], characterized in that
a relationship of μ_{eff}<μ1 is established between an effective static friction coefficient μ_{eff} between the outermost layer of the electrode laminate and an inner layer of the laminate film exterior material in a state where the electrolyte is poured in the laminate film exterior material and a static friction coefficient μ1 which is a larger one of a static friction coefficient between the positive electrode and the separator and that between the negative electrode and the separator, and
a relationship of mG<2PAμ_{eff} is established among a weight m [kg] of the electrode laminate, a contacting area A [m²] between the outermost layer of the electrode laminate and the inner layer of the laminate film exterior material, and an atmospheric pressure P [Pa].

7. A battery module constructed by an electrode laminate obtained by laminating positive and negative electrodes through separators and a laminate film exterior material housing the electrode laminate and electrolyte and having an impact resistance against an impact of at least G, characterized in that
a relationship of μ_{eff}<μ1 is established between an effective static friction coefficient μ_{eff} between the outermost layer of the electrode laminate and an inner layer of the laminate film exterior material in a state where the electrolyte is poured in the laminate film exterior material and a static friction coefficient μ1 which is a larger one of a static friction coefficient between the positive electrode and the separator and that between the negative electrode and the separator, and
a relationship of T [m]<2PAμ_{eff}/10³ dG is established among a thickness T of the electrode laminate, a specific gravity d [g/cm³] of the electrode laminate, a contacting area A [m²] between the outermost layer of the electrode laminate and the inner layer of the laminate film exterior material, and an atmospheric pressure P [Pa].

8. The battery module according to claim 6, characterized in that
assuming that a static friction coefficient between the outermost layer of the electrode laminate and the inner layer of the laminate film exterior material in a state where the electrolyte is not present is μ, the effective static friction coefficient is calculated based on μ_{eff}=eμ.

9. The battery module according to claim 8, characterized in that
the e assumes a value in a range of 0.11≦e≦0.12.

10. The battery module according to claim 6, characterized in that
the unit battery is a lithium ion secondary battery.

11. The battery module according to claim 7, characterized in that
assuming that a static friction coefficient between the outermost layer of the electrode laminate and the inner layer of the laminate film exterior material in a state where the electrolyte is not present is μ, the effective static friction coefficient is calculated based on μ_{eff}=eμ.

12. The battery module according to claim 7, characterized in that
the unit battery is a lithium ion secondary battery.
